(19) United States
(12) Patent Application Publication
(10) Pub. No.: US 2025/0336086 A1
(43) Pub. Date: Oct. 30, 2025

(54) AUGMENTED REALITY DEVICE FOR ACQUIRING THREE-DIMENSIONAL POSITION INFORMATION ABOUT HAND JOINTS, AND METHOD FOR OPERATING SAME

(71) Applicant: SAMSUNG ELECTRONICS CO., LTD., Suwon-si (KR)

(72) Inventors: Hwangpil PARK, Suwon-si (KR); Deokho KIM, Suwon-si (KR); Woojae KIM, Suwon-si (KR); Gunill LEE, Suwon-si (KR); Wonwoo LEE, Suwon-si (KR); Jiwon JEONG, Suwon-si (KR)

(73) Assignee: SAMSUNG ELECTRONICS CO., LTD., Suwon-si (KR)

(21) Appl. No.: 19/259,787

(22) Filed: Jul. 3, 2025

Related U.S. Application Data
(63) Continuation of application No. PCT/KR2023/019015, filed on Nov. 23, 2023.

(30) Foreign Application Priority Data
Jan. 4, 2023 (KR) 10-2023-0001327

(51) Int. Cl. G06T 7/73; G06T 5/80; G06V 10/77; G06V 10/82; G06V 40/10

(52) U.S. Cl. CPC G06T 7/73; G06T 5/80; G06V 10/77; G06V 40/11; G06T 2207/20081; G06T 2207/20084; G06T 2207/30168; G06T 2207/30196; G06T 2207/30244; G06V 10/82

(57) ABSTRACT

An augmented reality device for obtaining three-dimensional (3D) position information of a plurality of hand joints of a user includes a plurality of cameras configured to photograph the user's hand and obtain images; memory storing instructions; and at least one processor; the instructions, when executed, may cause the device to recognize the plurality of hand joints from the images; obtain two-dimensional (2D) joint coordinate values for feature points corresponding to the hand joints; retrieve, from a look up table (LUT), 3D position coordinate values corresponding to distortion model parameters of the cameras, a positional relationship between the cameras, and the 2D joint coordinate values; and output the 3D position information of the plurality of hand joints based on the 3D position coordinate values.

### CROSS-REFERENCE TO RELATED APPLICATIONS

This application is a by-pass continuation application of International Application No. PCT/KR2023/019015, filed on Nov. 23, 2023, which is based on and claims priority to Korean Patent Application No. 10-2023-0001327, filed on Jan. 4, 2023, in the Korean Intellectual Property Office, the disclosures of which are incorporated by reference herein in their entireties.

### BACKGROUND

### 1. Field

The present disclosure relates to an augmented reality (AR) device for obtaining three-dimensional (3D) position information of joints included in a user's hand and an operation method thereof. The present disclosure provides an AR device and operation method thereof for obtaining 3D position coordinate value information of joints included in a user's hand from two-dimensional (2D) images obtained by photographing the user's hand using a plurality of cameras.

### 2. Description of Related Art

Augmented reality (AR) is a technology that overlays virtual objects onto a physical environment space or real-world objects in the real world and shows them together, and AR devices using AR technology (e.g., smart glasses) have been used in everyday life for useful purposes such as information searching, route guidance, and image capturing by cameras. In particular, smart glasses are also being worn as fashion items and mainly used for outdoor activities.

Because AR devices cannot be operated via touch due to their nature, hand interaction using three-dimensional (3D) poses and gestures of a user's hand(s) is important as an input interface in order to provide AR services. For example, an AR service may provide a user interface that uses interaction with the user's hand(s), such as selecting a menu element, performing interaction with a virtual object, selecting an item, or placing an object in a virtual hand. Therefore, in order to implement more realistic AR technology, a technology for obtaining 3D position information of joints included in the hand and accurately tracking poses (shapes) of the hand and recognizing hand gestures by using the 3D position information is required.

To ensure freedom of the user's two hands, general AR devices use a vision-based hand tracking technology for recognizing a user's hand from an image obtained by a camera mounted on an AR device without using a separate external input device. AR devices may obtain 3D position information of joints included in a hand by using triangulation, based on a plurality of two-dimensional (2D) images, which are obtained in an area where their fields of view overlap by using a stereo camera including two or more cameras, and a positional relationship between the cameras. In the case of a typical red, green, and blue (RGB) camera, a 2D image may be distorted due to lens characteristics, and an error may occur in the process of correcting the distorted image. Due to the error occurring in the 2D image, an error may occur in 3D position information obtained through triangulation, and the accuracy of the 3D position information may decrease. In particular, the error occurring in the distorted image tends to increase toward edges of the image than toward a center thereof.

When the accuracy of 3D position information of joints of a hand is low, an AR device may not recognize or may incorrectly recognize poses or gestures of the hand.

### SUMMARY

According to an aspect of the disclosure, an augmented reality device for obtaining three-dimensional (3D) position information of a plurality of hand joints of a user, includes, a plurality of cameras configured to obtain a plurality of images by photographing a hand of the user; memory storing instructions; and at least one processor. The instructions, when executed by the at least one processor, individually or collectively, cause the augmented reality device to recognize the plurality of hand joints from the plurality of images obtained through the plurality of cameras, obtain a plurality of two-dimensional (2D) joint coordinate values for a plurality of feature points corresponding to the plurality of hand joints, obtain, from a look up table (LUT), a plurality of 3D position coordinate values corresponding to a plurality of distortion model parameters of the plurality of cameras, a positional relationship between the plurality of cameras, and the plurality of 2D joint coordinate values, and output the 3D position information of the plurality of hand joints based on the plurality of 3D position coordinate values.

The LUT may include the plurality of 2D position coordinate values, the first plurality of distortion model parameters, a plurality of camera positional relationship parameters, and the plurality of 3D position coordinate values, each of which may be pre-obtained, and the plurality of 2D position coordinate values may be obtained through a simulation that applies the plurality of distortion model parameters and the plurality of camera positional relationship parameters to the plurality of 3D position coordinate values.

The plurality of 3D position coordinate values included in the LUT may be coordinate values representing arbitrary 3D positions of the plurality of hand joints within a range of movable angles of upper body joints according to anatomical constraints of a musculoskeletal system of a human body.

The plurality of 3D position coordinate values included in the LUT may be obtained through a simulation of obtaining 2D projection coordinate values by projecting the plurality of 3D position coordinate values based on a plurality of camera positional relationship parameters and reflecting distortion of a plurality of lenses by applying the plurality of distortion model parameters to the obtained 2D projection coordinate values.

The instructions, when executed by the at least one processor, individually or collectively, may cause the augmented reality device to access the LUT and search the LUT to identify a distortion model parameter, a camera positional relationship parameter, and the plurality of 2D position coordinate values based on correspondences with the plurality of distortion model parameters of the plurality of lenses, the positional relationship between the plurality of cameras, and the obtained 2D joint coordinate values, and obtain, from the LUT, the plurality of 3D position coordinate values corresponding to the distortion model parameter, the camera positional relationship parameter, and the plurality of 2D position coordinate values.

The instructions, when executed by the at least one processor, individually or collectively, may cause the augmented reality device to input into an artificial intelligence (AI) model, the plurality of distortion model parameters of the plurality of lenses, the positional relationship between the plurality of cameras, and the plurality of 2D joint coordinate values, and the AI model may be trained using the LUT; and obtain the plurality of 3D position coordinate values through inference of the AI model.

The instructions, when executed by the at least one processor, individually or collectively, may cause the augmented reality device to correct distortion in the plurality of 2D joint coordinate values based on the plurality of distortion model parameters of the plurality of lenses and the positional relationship between the plurality of cameras, and rectify a plurality of orientations of the plurality of images; calculate a second plurality of 3D position coordinate values of the plurality of hand joints through triangulation based on the plurality of corrected 2D joint coordinate values, the rectified plurality of orientations, and the positional relationship between the plurality of cameras; and detect an error in the 3D position information of the plurality of hand joints by comparing the calculated second plurality of 3D position coordinate values with a second plurality of 3D position coordinate values obtained from the LUT.

According to an aspect of the disclosure, a method, performed by an augmented reality device, for obtaining three-dimensional (3D) position information of plurality of hand joints of a user, includes recognizing the plurality of hand joints from a plurality of images obtained by photographing a hand of the user using a plurality of cameras; obtaining a plurality of two-dimensional (2D) joint coordinate values for a plurality of feature points corresponding to the recognized plurality of hand joints; obtaining, from a look-up table (LUT) prestored in memory, 3D position coordinate values corresponding to distortion model parameters of the plurality of cameras, a positional relationship between the plurality of cameras, and the plurality of 2D joint coordinate values; and outputting the 3D position information of the plurality of hand joints based on the plurality of 3D position coordinate values.

The LUT may include a first plurality of 2D position coordinate values, a first plurality of distortion model parameters, a first plurality of camera positional relationship parameters, and a first plurality of 3D position coordinate values, each of which may be pre-obtained, and the first plurality of 2D position coordinate values may be obtained through a simulation that applies the first plurality of distortion model parameters and the first plurality of camera positional relationship parameters to the first plurality of 3D position coordinate values.

The plurality of 3D position coordinate values included in the LUT may be coordinate values representing arbitrary 3D positions of the plurality of hand joints within a range of movable angles of upper body joints according to anatomical constraints of a musculoskeletal system of a human body.

The plurality of 3D position coordinate values included in the LUT may be obtained through a simulation of obtaining 2D projection coordinate values by projecting the plurality of 3D position coordinate values based on the plurality of camera positional relationship parameters and reflecting distortion of a plurality of lenses by applying the plurality of distortion model parameters to the obtained 2D projection coordinate values.

The obtaining of the 3D position coordinate values may include accessing the LUT and searching the LUT to identify a distortion model parameter, a camera positional relationship parameter, and the plurality of 2D position coordinate values based on correspondences with the plurality of distortion model parameters of the plurality of lenses, the positional relationship between the plurality of cameras, and the plurality of 2D joint coordinate values; and obtaining, from the LUT, the plurality of 3D position coordinate values corresponding to the distortion model parameter, the camera positional relationship parameter, and the plurality of 2D position coordinate values.

The obtaining of the 3D position coordinate values may include inputting into an artificial intelligence model (AI), the plurality of distortion model parameters of the plurality of lenses, the positional relationship between the plurality of cameras, and the plurality of 2D joint coordinate values; and obtaining the plurality of 3D position coordinate values through inference of the AI model.

The method may further include correcting distortion in the plurality of 2D joint coordinate values based on the plurality of distortion model parameters of the plurality of lenses and the positional relationship between the plurality of cameras, and rectifying a plurality of orientations of the plurality of images; calculating a second plurality of 3D position coordinate values of the plurality of hand joints through triangulation based on the plurality of corrected 2D joint coordinate values, the rectified plurality of orientations, and the positional relationship between the plurality of cameras; and detecting an error in the 3D position information of the plurality of hand joints by comparing the calculated first 3D position coordinate values with a second plurality of 3D position coordinate values obtained from the LUT.

According to an aspect of the disclosure, a non-transitory computer-readable storage medium having at least one instruction recorded thereon, that, when executed by at least one processor of an augmented reality device, for obtaining three-dimensional (3D) position information of plurality of hand joints of a user, individually or collectively, cause the augmented reality device to recognize the plurality of hand joints from a plurality of images obtained by photographing a hand of the user using a plurality of cameras; obtain a plurality of two-dimensional (2D) joint coordinate values for a plurality of feature points of the recognized plurality of hand joints; obtain, from a prestored look-up table (LUT), 3D position coordinate values corresponding to distortion model parameters of the plurality of cameras, a positional relationship between the plurality of cameras, and the plurality of 2D joint coordinate values; and output the 3D position information of the plurality of hand joints based on the plurality of 3D position coordinate values.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 is a conceptual diagram illustrating an operation in which an augmented reality (AR) device obtains three-dimensional (3D) position information of hand joints, according to an embodiment of the present disclosure.

FIG. 2 is a flowchart of an operation method of an AR device, according to an embodiment of the present disclosure.

FIG. 3 is a block diagram illustrating components of an AR device according to an embodiment of the present disclosure.

FIG. 4 is a block diagram illustrating components of an AR device and a server, according to an embodiment of the present disclosure.

FIG. 5 illustrates a look-up table (LUT) according to an embodiment of the present disclosure.

FIG. 6 is a diagram illustrating an operation in which an AR device obtains 3D position coordinate values of hand joints, which are stored in a LUT, according to an embodiment of the present disclosure.

FIG. 7 is a diagram illustrating an operation in which an AR device obtains two-dimensional (2D) position coordinate values of hand joints, which are stored in a LUT, according to an embodiment of the present disclosure.

FIG. 8 is a diagram illustrating an operation in which an AR device obtains 3D position information of hand joints by using an artificial intelligence (AI) model, according to an embodiment of the present disclosure.

FIG. 9 is a diagram illustrating a method of training an AI model, according to an embodiment of the present disclosure.

FIG. 10 is a flowchart of a method, performed by an AR device, of determining the accuracy of 3D position information of hand joints, according to an embodiment of the present disclosure.

FIG. 11 is a diagram illustrating a user interface (UI) output by an AR device to notify whether a change in a hand joint recognition method is necessary, according to an embodiment of the present disclosure.

FIG. 12 is a diagram illustrating a UI output by an AR device to represent a recognition error of 3D position information of hand joints, according to an embodiment of the present disclosure.

FIG. 13 is a flowchart of a method, performed by an AR device, of determining a size of a region where 3D position information of hand joints is obtained via triangulation in an entire region of an image, according to an embodiment of the present disclosure.

FIG. 14 is a diagram illustrating a UI output by an AR device to display a region where an error occurs in 3D position information of hand joints in an entire region of an image, according to an embodiment of the present disclosure.

FIG. 15 is a diagram illustrating an operation in which an AR device determines a size of a region where 3D position information of hand joints is obtained using triangulation in an entire area of an image, according to an embodiment of the present disclosure.

### DETAILED DESCRIPTION

The embodiments described in the disclosure, and the configurations shown in the drawings, are only examples of embodiments, and various modifications may be made without departing from the scope and spirit of the disclosure.

As the terms used in embodiments of the present specification, general terms that are currently widely used are selected by taking into account functions in the present disclosure, but these terms may vary according to the intention of one of ordinary skill in the art, precedent cases, advent of new technologies, etc. Furthermore, specific terms may be arbitrarily selected by the applicant, and in this case, the meaning of the selected terms will be described in detail in the detailed description of a corresponding embodiment. Thus, the terms used herein should be defined not by simple appellations thereof but based on the meaning of the terms together with the overall description of the present disclosure.

Singular expressions used herein are intended to include plural expressions as well unless the context clearly indicates otherwise. All the terms used herein, which include technical or scientific terms, may have the same meaning that is generally understood by a person of ordinary skill in the art.

Throughout the present disclosure, when a part “includes” or “comprises” an element, unless there is a particular description contrary thereto, it is understood that the part may further include other elements, not excluding the other elements. Furthermore, terms, such as “unit”, “module”, etc., used herein indicate a unit for processing at least one function or operation, and may be implemented as hardware or software or a combination of hardware and software.

The expression “configured to (or set to)” used herein may be used interchangeably, according to context, with, for example, the expression “suitable for,” “having the capacity to,” “designed to,” “adapted to,” “made to,” or “capable of”. The term “configured to (or set to)” may not necessarily mean only “specifically designed to” in terms of hardware. Instead, the expression “a system configured to” may mean, in some contexts, the system being “capable of”, in conjunction with other devices or components. For example, the expression “a processor configured to (or set to) perform A, B, and C” may mean a dedicated processor (e.g., an embedded processor) for performing the corresponding operations, or a general-purpose processor (e.g., a central processing unit (CPU) or an application processor (AP)) capable of performing the corresponding operations by executing one or more software programs stored in a memory.

Furthermore, in the present disclosure, when a component is referred to as being “connected” or “coupled” to another component, it should be understood that the component may be directly connected or coupled to the other component, but may also be connected or coupled to the other component via another intervening component therebetween unless there is a particular description contrary thereto.

As used herein, ‘augmented reality (AR)’ refers to a technology for showing virtual images in a real-world physical environment space, or showing real-world objects and virtual images together.

As used herein, an ‘AR device’ is a device capable of realizing AR, and for example, may be implemented as eye glasses-shaped AR glasses worn on a user's face, as well as a head mounted display (HMID) apparatus, an AR helmet, or the like worn on the user's head.

In the present disclosure, functions related to artificial intelligence (AI) are performed via a processor and a memory. The processor may be configured as one or a plurality of processors. In this case, the one or plurality of processors may be a general-purpose processor such as a CPU, an AP, a digital signal processor (DSP), etc., a dedicated graphics processor such as a graphics processing unit (GPU) and a vision processing unit (VPU), or a dedicated AI processor such as a neural processing unit (NPU). The one or plurality of processors control input data to be processed according to predefined operation rules or AI model stored in the memory. In a case that the one or plurality of processors are a dedicated AI processor, the dedicated AI processor may be designed with a hardware structure specialized for processing a particular AI model.

The predefined operation rules or AI model are generated via a training process. In this case, the generation via the training process means that the predefined operation rules or AI model set to perform desired characteristics (or purposes) are generated by training a base AI model based on a large number of training data via a learning algorithm. The training process may be performed by an apparatus itself on which AI according to the present disclosure is performed, or via a separate server and/or system. Examples of a learning algorithm include, but are not limited to, supervised learning, unsupervised learning, semi-supervised learning, and reinforcement learning.

In the present disclosure, an ‘AI model’ may consist of a plurality of neural network layers. Each of the plurality of neural network layers has a plurality of weight values and performs neural network computations via calculations between a result of computations in a previous layer and the plurality of weight values. A plurality of weights assigned to each of the plurality of neural network layers may be optimized by a result of training the AI model. For example, the plurality of weights may be updated to reduce or minimize a loss or cost value obtained in the AI model during a training process. An artificial neural network model may include a deep neural network (DNN), such as a convolutional neural network (CNN), a recurrent neural network (RNN), a restricted Boltzmann machine (RBM), a deep belief network (DBN), a bidirectional recurrent DNN (BRDNN), or a deep Q-network (DQN), but is not limited thereto.

In the present disclosure, ‘vision recognition’ refers to image signal processing that involves inputting an image to an AI model and detecting an object in the input image, classifying the object as a category, or segmenting the object through inference using the AI model. In an embodiment of the present disclosure, vision recognition may refer to image processing that involves recognizing a user's hand in an image obtained by a camera by using an AI model, and obtaining position information of a plurality of feature points (e.g., joints) included in the hand.

As used herein, a ‘joint’ is a part of a human body where bones are connected to each other, and refers to one or more regions included in the upper body such as the neck, arms, and shoulders, as well as the hands including the fingers, wrists, and palms.

An embodiment of the present disclosure will be described more fully hereinafter with reference to the accompanying drawings so that the embodiment may be easily implemented by a person of ordinary skill in the art. However, the present disclosure may be implemented in different forms and should not be construed as being limited to embodiments set forth herein.

Hereinafter, embodiments of the present disclosure are described in detail with reference to the accompanying drawings.

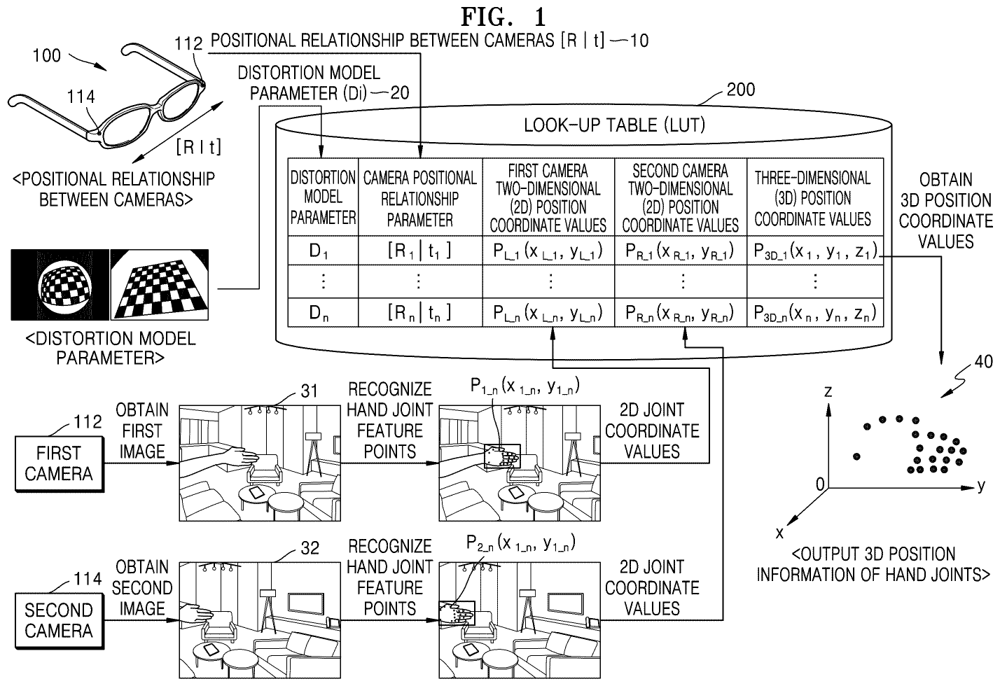

FIG. 1 is a conceptual diagram illustrating an operation in which an AR device 100 obtains three-dimensional (3D) position information of hand joints, according to an embodiment of the present disclosure.

The AR device 100 is a device capable of realizing AR, and may be configured as, for example, eye glasses-shaped AR glasses worn by a user on the face. In FIG. 1, the AR device 100 is illustrated as AR glasses, but is not limited thereto. For example, the AR device 100 may be implemented as an HMD apparatus, an AR helmet, or the like worn on the user's head.

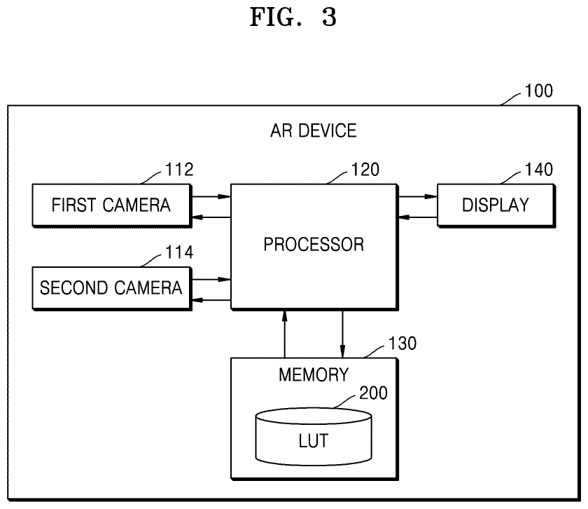

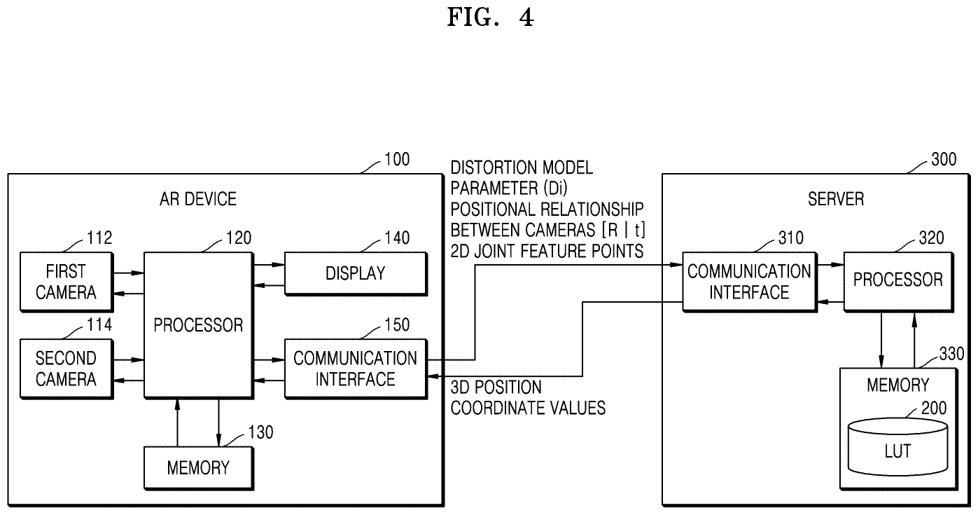

Referring to FIG. 1, the AR device 100 may include a first camera 112 and a second camera 114. In FIG. 1, only the minimum components for describing the functions and/or operations of the AR device 100 are illustrated, and the components included in the AR device 100 are not limited to those shown in FIG. 1. The components of the AR device 100 are described in detail with reference to FIGS. 3 and 4.

In an embodiment of the present disclosure, when the user wears the AR device 100 on his or her head, the first camera 112 is a camera configured to obtain an image of a real-world object corresponding to the user's left eye, and the second camera 114 is a camera configured to obtain an image of the real-world object corresponding to the user's right eye. Although FIG. 1 illustrates the AR device 100 as including two cameras, the present disclosure is not limited thereto. In an embodiment of the present disclosure, the AR device 100 may include three or more cameras.

The first camera 112 and the second camera 114 may have a relative positional relationship therebetween depending on an arrangement structure according to a size, shape, or design of the AR device 100. A positional relationship 10 between the cameras may include information about positions and orientations of the first camera 112 and the second camera 114 arranged at different locations of the AR device 100. In an embodiment of the present disclosure, the positional relationship 10 between the cameras may include a rotation matrix denoted by R and a translation vector denoted by t.

A distortion model parameter Dᵢ 20 is a parameter for correcting image distortion caused by physical characteristics of a camera lens. In a case that an image of an object is obtained by using a camera, light may be projected at a different location than an actual position of the object according to the physical characteristics of a lens and the position of the object, causing distortion in the image. An image distortion model may be defined according to the physical characteristics of the lens. For example, distortion models may include a barrel distortion model, a Brown distortion model, or a pincushion distortion model, but are not limited thereto. The distortion model parameter 20 may include parameters for, after an image is obtained by using a camera, correcting the image based on a distortion model which is defined according to the physical characteristics of a lens of the camera. The distortion model parameter 20 may be calculated through a process of obtaining an image of an object having a pattern through a camera and calibrating the pattern of the object included in the obtained image. In an embodiment of the present disclosure, distortion models may be defined according to physical characteristics of lenses respectively included in the first camera 112 and the second camera 114. The distortion model parameters 20 may be pre-calculated according to the distortion models respectively defined for the first camera 112 and the second camera 114.

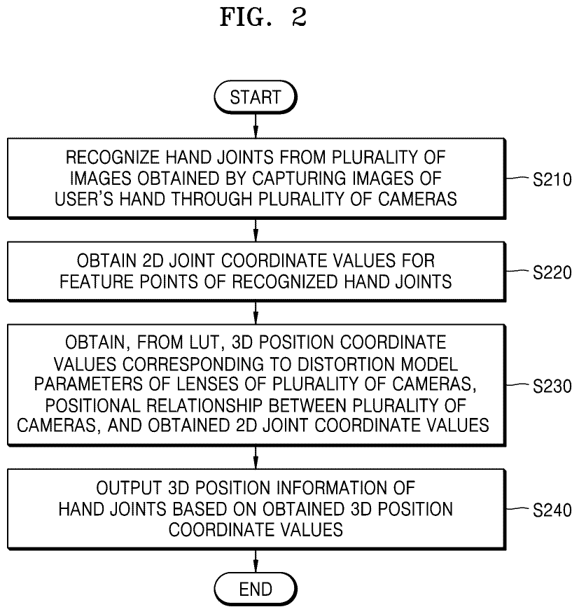

The AR device 100 may recognize hand joints of the user from images obtained using the first camera 112 and the second camera 114, and obtain 3D position information about the recognized hand joints from a look-up table (LUT) 200. Hereinafter, functions and/or operations of the AR device 100 are described in detail with reference to FIGS. 1 and 2 together.

FIG. 2 is a flowchart of an operation method of the AR device 100, according to an embodiment of the present disclosure.

Referring to FIG. 2, in operation S210, the AR device 100 recognizes hand joints from a plurality of images obtained by photographing the user's hand using a plurality of cameras. Referring to FIG. 1 together, the AR device 100 may obtain a first image 31 by photographing the user's hand located in a real-world space by using the first camera 112, and obtain a second image 32 by photographing the user's hand by using the second camera 114. The AR device 100 may recognize feature points of hand joints from each of the first image 31 and the second image 32. As used in the present disclosure, a ‘joint’ is a part where a plurality of bones are connected to each other, and refers to one or more regions included in fingers, back of the hand, or palm. As used herein, a ‘feature point’ may mean a point in an image that is easily distinguishable or identifiable from the surrounding background. Feature points of hand joints may include, for example, at least one of a feature point of a wrist joint, a feature point of a palm joint, and a feature point of a finger (thumb, index finger, middle finger, ring finger, or little finger).

In an embodiment of the present disclosure, the AR device 100 may recognize feature points of hand joints from the first image 31 and the second image 32 by using an AI model. The ‘AI model’ may include a DNN model that is trained to recognize an object (e.g., the user's hand) and feature points of the object from image data input from a camera. The DNN model may include, for example, at least one of a CNN, an RNN, an RBM, a DBN, a BRDNN, and a DQN.

However, the present disclosure is not limited to the AR device 100 recognizing feature points of hand joints from the first image 31 and the second image 32 by using an AI model. In an embodiment of the present disclosure, by using known image processing techniques, the AR device 100 may recognize the user's hand from each of the first image 31 and the second image 32 and recognize feature points for joints included in the hand.

In operation S220 of FIG. 2, the AR device 100 obtains two-dimensional (2D) joint coordinate values for feature points of the recognized hand joints. Referring to FIG. 1 together, the AR device 100 may obtain 2D joint coordinate values P_{1_n} of hand joints recognized from the first image 31. The 2D joint coordinate values P_{1_n} may be 2D position coordinate values (x_{1_n}, y_{1_n}) of feature points of the hand joints recognized from the first image 31. Similarly, the AR device 100 may obtain 2D joint coordinate values P_{2_n} of the hand joints recognized from the second image 32. The 2D joint coordinate values P_{2_n} may be 2D position coordinate values (x_{2_n}, y_{2_n}) of feature points of the hand joints recognized from the second image 32.

In operation S230 of FIG. 2, the AR device 100 obtains, from a LUT, 3D position coordinate values corresponding to distortion model parameters of lenses of the plurality of cameras, a positional relationship between the plurality of cameras, and the obtained 2D joint coordinate values. The LUT may be stored in a memory (130 of FIG. 3) of the AR device 100, or may be stored in a server (300 of FIG. 4) or an external device. Referring to FIG. 1 together, the LUT 200 may include a plurality of distortion model parameters Dᵢ to Dₙ, a plurality of camera positional relationship parameters [R₁|t₁] to [Rₙ|tₙ], a plurality of first camera 2D position coordinate values P_{L_1} to P_{L_n}, a plurality of second camera 2D position coordinate values P_{R_1} to P_{R_n}, and a plurality of 3D position coordinate values P_{3D_1} to P_{3D_n}. The plurality of 3D position coordinate values P_{3D_1} to P_{3D_n} included in the LUT 200 are coordinate values representing arbitrary 3D positions of hand joints within a range of movable angles of upper body joints according to anatomical constraints of the musculoskeletal system of the human body, and may be pre-obtained coordinate values. The plurality of distortion model parameters Dᵢ to Dₙ may include parameters calculated through mathematical modeling to correct image distortion caused by an arbitrary distortion model.

The plurality of camera positional relationship parameters [R₁|t₁] to [Rₙ|tₙ] may include a plurality of rotation matrices R and a plurality of translation vectors t. The plurality of 3D position coordinate values P_{3D_1} to P_{3D_n} may respectively correspond to the plurality of first camera 2D position coordinate values P_{L_1} to P_{L_n} and the plurality of second camera 2D position coordinate values P_{R_1} to P_{R_n} according to the plurality of distortion model parameters Dᵢ to Dₙ and the plurality of camera positional relationship parameters [R₁|t₁] to [Rₙ|tₙ]. For example, the first 3D position coordinate values P_{3D_1} may correspond to the first camera 2D position coordinate values P_{L_1} and the second camera 2D position coordinate values P_{R_1} according to the first distortion model parameter D₁ and the first camera positional relationship parameter R₁|t₁, and the n-th 3D position coordinate values P_{3D_n} may correspond to the first camera 2D position coordinate values P_{L_n} and the second camera 2D position coordinate values P_{R_n} according to the n-th distortion model parameter Dₙ and the n-th camera positional relationship parameter Rₙ|tₙ. In an embodiment of the present disclosure, the plurality of first camera 2D position coordinate values P_{L_1} to P_{L_n} and the plurality of second camera 2D position coordinate values P_{R_1} to P_{R_n} included in the LUT 200 may be obtained by simulating the plurality of 3D position coordinate values P_{3D_1} to P_{3D_n} to reflect distortion caused by the cameras by using the plurality of camera positional relationship parameters [R₁|t₁] to [Rₙ|tₙ] and the plurality of distortion model parameters D₁ to Dₙ.

The AR device 100 may access the LUT 200 and search the LUT 200 for a distortion model parameter, a camera positional relationship parameter, first camera 2D position coordinate values, and second camera 2D position coordinate values that are respectively identical or similar to the distortion model parameters Dᵢ 20 of the first camera 112 and the second camera 114, the positional relationship [R|t] 10 between the first camera 112 and the second camera 114, the 2D joint coordinate values P_{1_n} obtained from the first image 31, and the 2D joint coordinate values P_{2_n} obtained from the second image 32. The AR device 100 may obtain, from the LUT 200, 3D position coordinate values corresponding to a found distortion model parameter, found camera positional relationship parameter, found first camera 2D position coordinate values, and found second camera 2D position coordinate values. For example, as a result of searching the LUT 200, in a case that the first camera positional relationship parameter [R₁|t₁] identical to or similar to the positional relationship 10 between the first camera 112 and the second camera 114 is found, the first distortion model parameter D₁ identical to or similar to the distortion model parameters 20 of the first camera 112 and the second camera 114 is found, the first camera 2D position coordinate values P_{L_1} identical to or similar to the 2D joint coordinate values P_{1_n} obtained from the first image 31 is found, and the second camera 2D position coordinate values P_{R_1} identical to or similar to the 2D joint coordinate values P_{2_n} obtained from the second image 32 is found, the AR device 100 may obtain, from the LUT 200, the first 3D position coordinate values P_{3D_1} corresponding to the first camera positional relationship parameter [R₁|t₁], the first distortion model parameter D₁, the first camera 2D position coordinate values P_{L_1}, and the second camera 2D position coordinate values P_{R_1}.

In operation S240 of FIG. 2, the AR device 100 outputs 3D position information of the hand joints based on the obtained 3D position coordinate values. Referring to FIG. 1 together, the AR device 100 may output the 3D position coordinate values (e.g., the first 3D position coordinate values P_{3D_1}) obtained from the LUT 200 as 3D position information 40 of the hand joint. In an embodiment of the present disclosure, the AR device 100 may display the 3D position information 40 of the hand joints on the display (140 of FIG. 3).

To ensure the freedom of the user's two hands, AR devices use a vision-based hand tracking technology for recognizing a user's hand from an image obtained by a camera mounted on an AR device without using a separate external input device. AR devices may obtain 3D position information of joints included in a hand by using triangulation, based on a plurality of 2D images, which are obtained in an area where their fields of view overlap by using a stereo camera including two or more cameras, and a positional relationship between the cameras. In the case of a typical red, green, and blue (RGB) camera, a 2D image may be distorted due to lens characteristics, and an error may occur in the process of correcting the distorted image. Due to the error occurring in the 2D image, an error may occur in 3D position information obtained through triangulation, and the accuracy of the 3D position information may decrease. In particular, the error occurring in the distorted image tends to increase toward edges of the image than toward a center thereof.

The present disclosure aims to provide an AR device and operation method thereof for obtaining 3D position information of joints included in a user's hand from a plurality of 2D images obtained by photographing the user's hand using a plurality of cameras.

Unlike in the related art, the AR device 100 according to the embodiment illustrated in FIGS. 1 and 2 does not use a method of performing distortion correction and triangulation, but instead obtains 3D position coordinate values of P_{3D} Corresponding to the 2D joint coordinate values P_{1_n}, and P_{2_n} of the hand joints from the LUT 200 pre-obtained via a simulation that reflects a positional relationship between the cameras and distortion due to physical characteristics of the lenses, and outputs the obtained 3D position coordinate values P_{3D} as 3D position information of the hand joint, thereby preventing errors that occur in the process of correcting the distortion and improving the accuracy of the 3D position information of the hand joint. Therefore, according to an embodiment of the present disclosure, the AR device 100 provides a technical effect of improving the recognition accuracy and stability of a hand pose or gesture in a vision-based hand tracking technology that uses 3D position information of a hand joint.

In addition, according to an embodiment of the present disclosure, the AR device 100 obtains 3D position information of hand joints by searching the LUT 200, which may simplify a hand tracking process compared to the existing method of obtaining 3D position information of a hand joint through a distortion correction process and triangulation. Therefore, the AR device 100 of the present disclosure has advantages of fast processing speed for hand tracking and real-time processing.

According to an embodiment of the present disclosure, the LUT 200 includes the plurality of 3D position coordinate values P_{3D_1} to P_{3D_n} simulated according to the plurality of distortion model parameters D₁ to Dₙ arbitrarily generated and the plurality of camera positional relationship parameters [R₁|t₁] to [Rₙ|tₙ] regarding a geometric relationship between camera positions, and thus has the advantage of being universally applicable without the need to change or tune the LUT 200 for each device.

FIG. 3 is a block diagram illustrating components of an AR device 100 according to an embodiment of the present disclosure.

Referring to FIG. 3, the AR device 100 may include the first camera 112, the second camera 114, a processor 120, the memory 130, and the display 140. The first camera 112, the second camera 114, the processor 120, the memory 130, and the display 140 may be electrically and/or physically connected to each other. FIG. 3 illustrates only essential components for describing operations of the AR device 100, and the components included in the AR device 100 are not limited to those shown in FIG. 3. In an embodiment of the present disclosure, the AR device 100 may further include a communication interface (150 of FIG. 4) for performing data communication with the server (300 of FIG. 4) or an external device. In an embodiment of the present disclosure, the AR device 100 may not include the display 140.

In an embodiment of the present disclosure, the AR device 100 may be implemented as a portable device, and in this case, the AR device 100 may further include a battery for supplying power to the first camera 112, the second camera 114, the processor 120, the display 140, and the communication interface 150.

The first camera 112 and the second camera 114 are each configured to obtain an image of an object by photographing the object in a real-world space. In an embodiment of the present disclosure, the first camera 112 and the second camera 114 may obtain a 2D image including a user's hand by photographing the user's hand. The first camera 112 and the second camera 114 may construct a stereo camera that obtains 3D position coordinate values of an object through triangulation, based on 2D images obtained in an area where fields of view overlap and a positional relationship between the cameras. In an embodiment of the present disclosure, the first camera 112 and the second camera 114 may be implemented in a small form factor so as to be mounted on the AR device 100, and may be lightweight RGB cameras that consume low power. However, the first camera 112 and the second camera 114 are not limited thereto, and in an embodiment of the present disclosure, they may be implemented as any type of camera known in the art, such as an RGB-depth camera, a stereo fisheye camera, a grayscale camera, or an infrared camera, including a depth estimation function.

The first camera 112 and the second camera 114 may each include a lens module, an image sensor, and an image processing module. The first camera 112 and the second camera 114 may each obtain a still image or a video of the user's hand through an image sensor (e.g., a complementary metal-oxide-semiconductor (CMOS) or charge-coupled device (CCD) sensor). The video may include a plurality of image frames obtained in real time by photographing an object in a real-word space, including the user's hand, through the first camera 112 and the second camera 114. An image processing module may encode a still image consisting of a single image frame or video data consisting of a plurality of image frames obtained through the image sensor, and transmit the encoded data to the processor 120.

In all figures of the present disclosure, the AR device 100 is illustrated to include the two cameras, including the first camera 112 and the second camera 114, but is not limited thereto. In an embodiment of the present disclosure, the AR device 100 may include three or more cameras.

The processor 120 may execute one or more instructions of a program stored in the memory 130. The processor 120 may be composed of hardware components that perform arithmetic, logic, and input/output (I/O) operations, and image processing. In FIG. 3, the processor 120 is shown as a single element, but is not limited thereto. In an embodiment of the present disclosure, the processor 120 may be configured as one or a plurality of elements. The processor 120 may be a general-purpose processor such as a CPU, an AP, a DSP, etc., a dedicated graphics processor such as a GPU, a VPU, etc., or a dedicated AI processor such as an NPU. The processor 120 may control input data to be processed according to predefined operation rules or AI model. In a case that the processor 120 is a dedicated AI processor, the dedicated AI processor may be designed with a hardware structure specialized for processing a particular AI model.

The processor 120 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing a variety of the recited/disclosed functions, e.g., in a distributed manner. At least one processor may execute program instructions to achieve or perform various functions.

For example, the memory 130 may include at least one type of storage medium from among a flash memory-type memory, a hard disk-type memory, a multimedia card micro-type memory, a card-type memory (e.g., a Secure Digital (SD) card or an eXtreme Digital (XD) memory), random access memory (RAM), static RAM (SRAM), read-only memory (ROM), electrically erasable programmable ROM (EEPROM), PROM, or an optical disc.

The memory 130 may store instructions related to functions and/or operations, performed by the AR device 100, for obtaining 3D position information of joints of a user's hand from images obtained by the first camera 112 and the second camera 114. In an embodiment of the present disclosure, the memory 130 may store at least one of instructions, algorithms, data structures, program code, and application programs readable by the processor 120. The instructions, algorithms, data structures, and program code stored in the memory 130 may be implemented in programming or scripting languages such as C, C++, Java, assembler, etc.

In the following embodiments, the processor 120 may be implemented by executing instructions or program code stored in the memory 130.

The processor 120 may obtain a first image of the user's hand captured by the first camera 112, and obtain a second image of the user's hand captured by the second camera 114. In an embodiment of the present disclosure, the processor 120 may obtain video data composed of a plurality of image frames captured in real time by the first camera 112 and the second camera 114.

The processor 120 may recognize hand joints from each of the first image and the second image, and obtain 2D joint coordinate values for feature points of the hand joints. In an embodiment of the present disclosure, the AR device 100 may recognize feature points of hand joints from the first image 31 and the second image 32 by using an AI model. The ‘AI model’ may include a DNN model trained to recognize the feature points of the hand joints from input image data. The DNN model may be, for example, a CNN model. However, the DNN model is not limited thereto, and may include, for example, at least one of an RNN, an RBM, a DBN, a BRDNN, a DQN. In an embodiment of the present disclosure, by using known image processing techniques, the processor 120 may recognize the user's hand from each of the first image 31 and the second image 32 and recognize feature points for joints included in the hand. The processor 120 may obtain 2D joint coordinate values of the recognized feature points of the hand joints. The 2D joint coordinate values may include x-axis coordinate value information and y-axis coordinate value information within the 2D image.

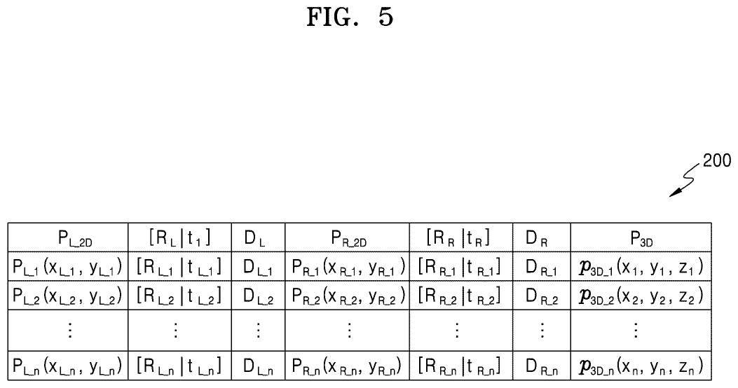

The processor 120 may obtain, from the LUT 200 prestored in the memory 130, 3D position coordinate values corresponding to a distortion model parameter calculated according to the lens modules of the first camera 112 and the second camera 114, a positional relationship between the first camera 112 and the second camera 114, and 2D joint coordinate values of hand joint feature points obtained from the first image and the second image. In the embodiment illustrated in FIG. 3, the LUT 200 may be stored on-device in a storage space of the memory 130 of the AR device 100. The LUT 200 may include data regarding a plurality of distortion model parameters, a plurality of camera positional relationship parameters, a plurality of first camera 2D position coordinate values, a plurality of second camera 2D position coordinate values, and a plurality of 3D position coordinate values. The plurality of 3D position coordinate values are coordinate values representing arbitrary 3D positions of hand joints within a range of movable angles of upper body joints according to anatomical constraints of the musculoskeletal system of the human body, and may be pre-obtained coordinate values. The plurality of 3D position coordinate values may respectively correspond to the plurality of first camera 2D position coordinate values and respectively correspond to the plurality of second camera 2D position coordinate values according to the plurality of distortion model parameters and the plurality of camera positional relationship parameters. In an embodiment of the present disclosure, the plurality of first camera 2D position coordinate values and the plurality of second camera 2D position coordinate values included in the LUT 200 may be obtained by simulating the plurality of 3D position coordinate values to reflect distortion caused by the cameras by using the plurality of camera positional relationship parameters and the plurality of distortion model parameters. The LUT 200 is described in detail with reference to FIG. 5.

Although it is illustrated and described in FIG. 3 that the LUT 200 is stored in the memory 130, the present disclosure is not limited to the above embodiment. In an embodiment of the present disclosure, the LUT 200 may be stored in the server (300 of FIG. 4) or an external device. An embodiment in which the LUT 200 is stored in the server 300 is described in more detail with reference to FIG. 4.

The processor 120 may access the LUT 200 and search the LUT 200 for a distortion model parameter, a camera positional relationship parameter, first camera 2D position coordinate values, and second camera 2D position coordinate values that are respectively identical or similar to distortion model parameters of the first camera 112 and the second camera 114, a positional relationship between the first camera 112 and the second camera 114, and 2D joint coordinate values respectively obtained from the first image and the second image. The processor 120 may obtain, from the LUT 200, 3D position coordinate values corresponding to the found distortion model parameter, found camera positional relationship parameter, found first camera 2D position coordinate values, and found second camera 2D position coordinate values.

The processor 120 may output 3D position information of the hand joints based on the 3D position coordinate values obtained from the LUT 200. In an embodiment of the present disclosure, the processor 120 may control the display 140 to display the 3D position information of the hand joint.

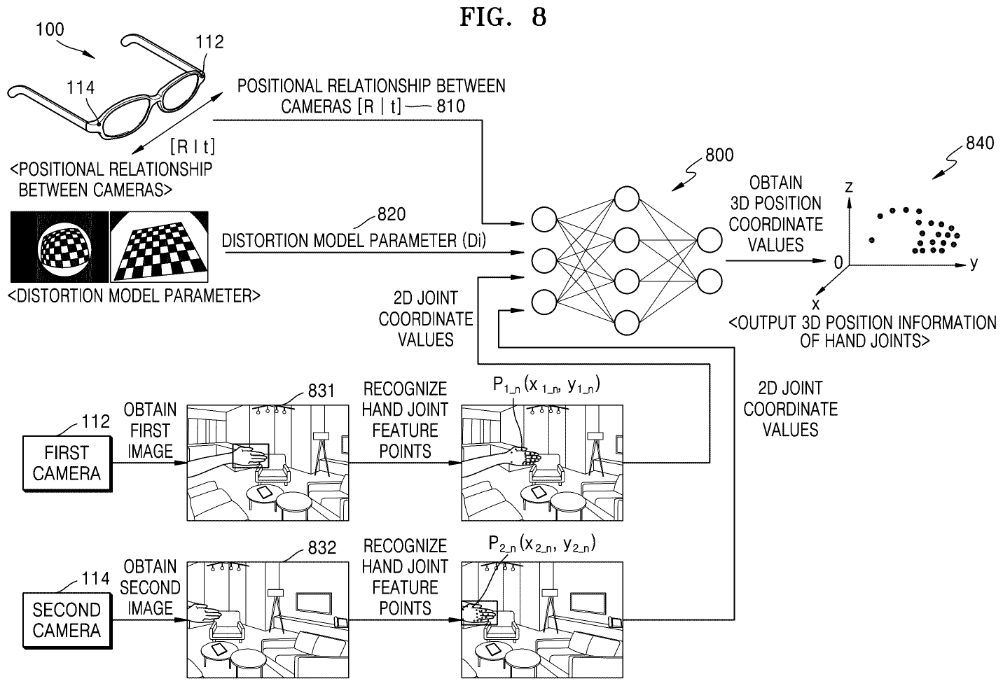

In an embodiment of the present disclosure, the processor 120 may input distortion model parameters of the lens modules of the first camera 112 and the second camera 114, a positional relationship between the first camera 112 and the second camera 114, and 2D joint coordinate values respectively obtained from the first image and the second image to an AI model that is trained using pieces of information included in the LUT 200, and obtain 3D position coordinate values through inference using the AI model 800. An embodiment in which the processor 120 obtains 3D position coordinate values by using the AI model 800 is described in detail with reference to FIG. 8.

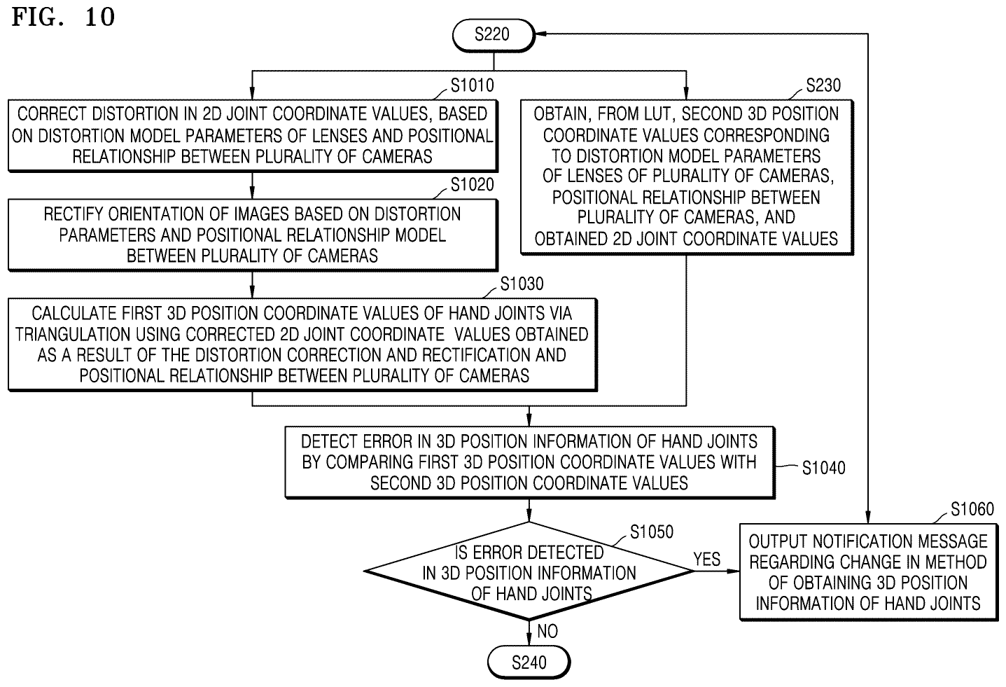

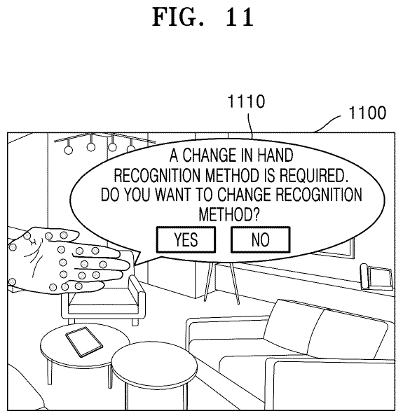

In an embodiment of the present disclosure, the processor 120 may correct distortion in the 2D joint coordinate values based on the distortion model parameters of the first camera 112 and the second camera 114 and the positional relationship between the first camera 112 and the second camera 114, and perform rectification on orientations of the first image and the second image. The processor 120 may calculate first 3D position coordinate values of hand joints through triangulation by using corrected 2D joint coordinate values resulting from the distortion correction and rectification and the positional relationship between the first camera 112 and the second camera 114. The processor 120 may detect an error in 3D position information of the hand joints by comparing the calculated first 3D position coordinate values with second 3D position coordinate values obtained from the LUT 200. In an embodiment of the present disclosure, the processor 120 may control the display 140 to display a position of the hand joints in which the error is detected, in a color that is distinct from that for a position in which the error is not detected. An embodiment in which the processor 130 detects an error in 3D position information of hand joints and displays a region in which the error is detected is described in detail with reference to FIGS. 10 and 11.

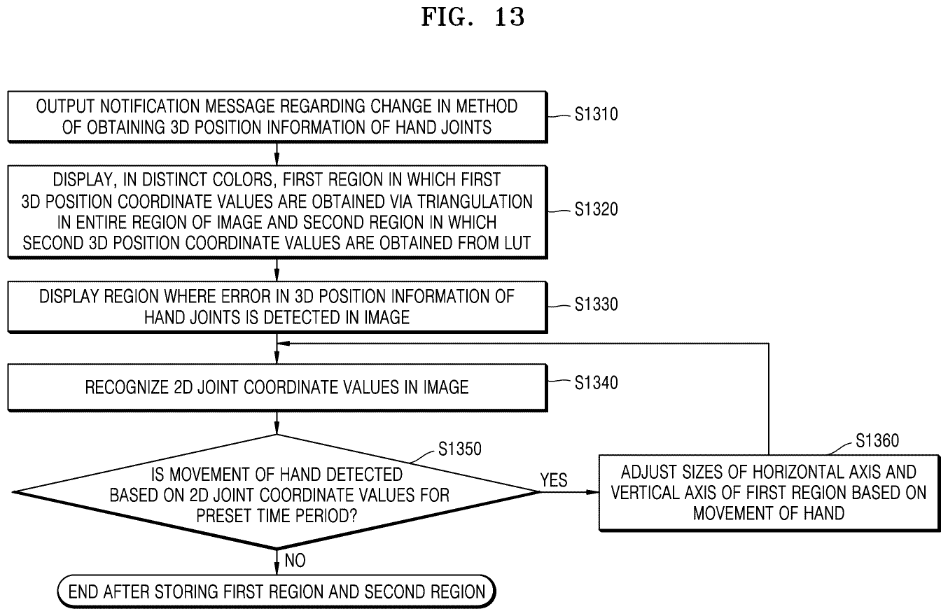

In an embodiment of the present disclosure, the processor 120 may control the display 140 to display, in distinct colors, a first region in which first 3D position coordinate values are obtained through triangulation in an entire region of a stereo image, and a second region in which second 3D position coordinate values are obtained from the LUT 200. In an embodiment of the present disclosure, the processor 120 may detect a movement of the user's hand for adjusting a size of the first region, and change sizes of horizontal and vertical axes of the first region based on the detected movement of the user's hand. An embodiment in which the processor 120 displays the first region and the second region in distinct colors and adjusts the size of the first region based on the movement of the user's hand is described in detail with reference to FIGS. 13 to 15.

The display 140 is configured to display a stereo image obtained by capturing images using the first camera 112 and the second camera 114. As described above, the display 140 may display a graphical user interface (GUI) that represents 3D position information of feature points of hand joints on an image according to control by the processor 130. In an embodiment of the present disclosure, the display 140 may display a bounding box in a region around the recognized user's hand.

The display 140 may consist of at least one of, for example, a liquid crystal display (LCD), a thin film transistor LCD (TFT-LCD), an organic light-emitting diode (OLED) display, a flexible display, a 3D display, and an electrophoretic display. In an embodiment of the present disclosure, in a case that the AR device 100 is configured as AR glasses, the display 140 may further include an optical engine for projecting a virtual image or a GUI (e.g., a feature point GUI or a bounding box GUI). The optical engine may be configured to generate light of the virtual image or the GUI, and may be configured as a projector including an image panel, an illumination optical system, a projection optical system, etc. The optical engine may be disposed in a frame or temples of the AR glasses.

FIG. 4 is a block diagram illustrating components of the AR device 100 and the server 300, according to an embodiment of the present disclosure.

Referring to FIG. 4, the AR device 100 may further include the communication interface 150 that performs data communication with the server 300. The first camera 112, the second camera 114, and the processor 120 included in the AR device 100 are respectively the same as the first camera 112, the second camera 114, and the processor 120 illustrated in FIG. 3, and therefore, for additional implementation details, reference may be made to the descriptions of FIG. 3.

The communication interface 150 may transmit and receive data to and from the server 300 over a wired or wireless communication network, and process the data. The communication interface 150 may perform data communication with the server 300 by using at least one of data communication methods including, for example, wired local area network (LAN), wireless LAN, Wi-Fi, Bluetooth, ZigBee, Wi-Fi Direct (WFD), Infrared Data Association (IrDA), Bluetooth Low Energy (BLE), near field communication (NFC), wireless broadband Internet (WiBro), World Interoperability for Microwave Access (WiMAX), Shared Wireless Access Protocol (SWAP), Wireless Gigabit Alliance (WiGig), and radio frequency (RF) communication. However, the present disclosure is not limited thereto, and when the AR device 100 is implemented as a mobile device, the communication interface 150 may transmit and receive data to and from the server 300 over a network that conforms to mobile communication standards such as code division multiple access (CDMA), wideband CDMA (WCDMA), 3rd generation (3G), 4th generation (4G) (or long-term evolution (LTE)), 5th generation (5G), sub-6, and/or a communication method using millimeter waves (mmWave).

In an embodiment of the present disclosure, the communication interface 150 may, according to control by the processor 120, transmit, to the server 300, distortion model parameters Dᵢ obtained according to physical characteristics of the lenses included in the first camera 112 and the second camera 114, a positional relationship [R|t] between the first camera 112 and the second camera 114, and data of 2D joint feature points respectively obtained from the first image and the second image, and receive, from the server 300, 3D position coordinate values obtained by searching the LUT 200. The communication interface 150 may provide the processor 130 with data of the 3D position coordinate values received from the server 300.

The server 300 may include a communication interface 310 for communicating with the AR device 100, a memory 330 for storing at least one instruction or program code, and a processor 320 configured to execute the at least one instruction or program code stored in the memory 330.

The memory 330 of the server 300 may store the LUT 200. Because the LUT 200 stored in the server 300 is the same as the LUT 200 illustrated in FIG. 1 and described with reference to FIG. 3. Therefore, for additional implementation details, reference may be made to the descriptions of FIG. 1. The server 300 may receive the distortion model parameters Dᵢ, positional relationship [R|t], and data of 2D joint feature points from the AR device 100 via the communication interface 310. The processor 320 of the server 300 may access the LUT 200, search the LUT 200 for a distortion model parameter, a camera positional relationship parameter, and 2D position coordinate values that are respectively identical or similar to the distortion model parameters Dᵢ, positional relationship [R|t], and data of 2D joint feature points received from the AR device 100, and obtain, from the LUT 200, 3D position coordinate values corresponding to the found distortion model parameter, found camera positional relationship parameter, and found 2D position coordinate values. The processor 320 may control the communication interface 310 to transmit data of the 3D position coordinate values to the AR device 100.

In general, the AR device 100 is implemented in the form of AR glasses worn on a person's face or a head-mounted device worn on a person's head, and is designed in a small form factor for portability. Therefore, the storage capacity of the memory 130 of the AR device 100, the computational processing speed of the processor 120, etc. may be limited compared to those of the server 300. Thus, after performing an operation requiring the storage of a large amount of data and a large number of computations, the server 300 may transmit necessary data (e.g., 3D position coordinate value data) to the AR device 100 via a communication network. In this way, the AR device 100 may reduce the processing time required to obtain 3D position information of hand joints and implement real-time hand interaction by receiving and using data representing 3D position coordinate values from the server 300 without a large capacity of memory and a processor with fast computational capability.

FIG. 5 illustrates the LUT 200 according to an embodiment of the present disclosure.

Referring to FIG. 5, the LUT 200 may include a plurality of 2D position coordinate values P_{L_2D}, a plurality of camera positional relationship parameters [R_{L}|t_{L}], and a plurality of distortion model parameters D_{L}, which are pre-obtained with respect to a first camera (a left-eye camera), a plurality of 2D position coordinate values P_{R_2D}, a plurality of camera positional relationship parameters [R_{R}|t_{R}], and a plurality of distortion model parameters D_{R}, which are pre-obtained with respect to a second camera (a right-eye camera), and a plurality of pre-obtained 3D position coordinate values P_{3D}.

The plurality of camera positional relationship parameters [R_{L}|t_{L}] for the first camera may include a plurality of rotation matrices R_{L_1} to R_{L_n} and a plurality of translation vectors t_{L_1} to t_{L_n}. A rotation matrix includes angle information for rotating the first camera based on an x-axis, a y-axis, and a z-axis according to a geometric position of the first camera. A translation vector is composed of a vector including a distance of movement for changing an object-oriented coordinate system to a camera-oriented coordinate system.

The plurality of distortion model parameters D_{L} for the first camera may include parameters for correcting distortion in an image according to a distortion model defined by physical characteristics of a lens of the first camera. The plurality of distortion model parameters D_{L} may include parameters calculated through mathematical modeling to correct distortion in an image by an arbitrary distortion model.

The plurality of 2D position coordinate values P_{L_2D} for the first camera may be obtained by simulating a plurality of 3D position coordinate values P_{3D} using the plurality of camera positional relationship parameters [R_{L}|t_{L}] and the plurality of distortion model parameters D_{L}. In other words, the plurality of 2D position coordinate values P_{L_2D} may be coordinate values obtained through a simulation that reflects a positional relationship for the first camera and distortion of the lens of the first camera.

Descriptions of the plurality of camera positional relationship parameters [R_{R}|t_{R}], the plurality of distortion model parameters D_{R}, and the plurality of 2D position coordinate values P_{R_2D} for the second camera are the same as descriptions of the plurality of camera positional relationship parameters [R_{L}|t_{L}], the plurality of distortion model parameters D_{L}, and the plurality of 2D position coordinate values P_{L_2D} for the first camera, except that the second camera is a right-eye camera, and thus, for additional implementation details, reference may be made to the descriptions of the first camera.

The plurality of 3D position coordinate values P_{3D} included in the LUT 200 may respectively correspond to the plurality of 2D position coordinate values P_{L_2D}, the plurality of camera positional relationship parameters [R_{L}|t_{L}], and the plurality of distortion model parameters D_{L} for the first camera (left-eye camera), and respectively correspond to the plurality of 2D position coordinate values P_{R_2D}, the plurality of camera positional relationship parameters [R_{R}|t_{R}], and the plurality of distortion model parameters D_{R} for the second camera (right-eye camera). For example, first 3D position coordinate values p_{3D_1} may correspond to first 2D position coordinate values P_{L_1} for the first camera, a first positional relationship parameter [R_{L_1}|t_{L_1}] for the first camera, a first distortion model parameter D_{L_1} of the first camera, first 2D position coordinate values P_{R_1} for the second camera, a first positional relationship parameter [R_{R_1} t_{R}_₁] for the second camera, and a first distortion model parameter D_{R_1} of the second camera. Similarly, n-th_{3D} position coordinate values p_{3D_n} may correspond to n-th 2D position coordinate values P_{L_n} for the first camera, an n-th positional relationship parameter [R_{L_n}|t_{L_n}] for the first camera, an n-th distortion model parameter D_{L_n} of the first camera, first 2D position coordinate values P_{R_n} for the second camera, an n-th positional relationship parameter [R_{R_n}|t_{R_n}] for the second camera, and an n-th distortion model parameter D_{R_n} of the second camera.

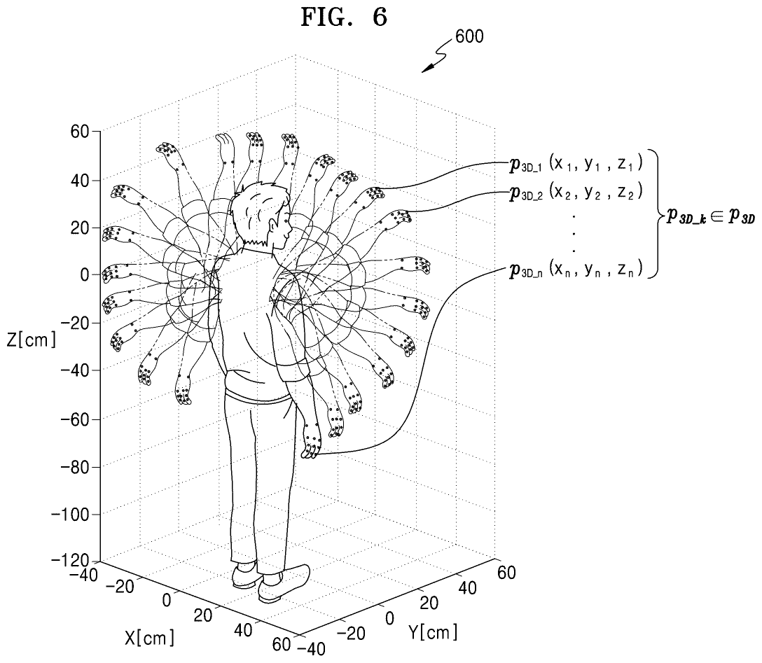

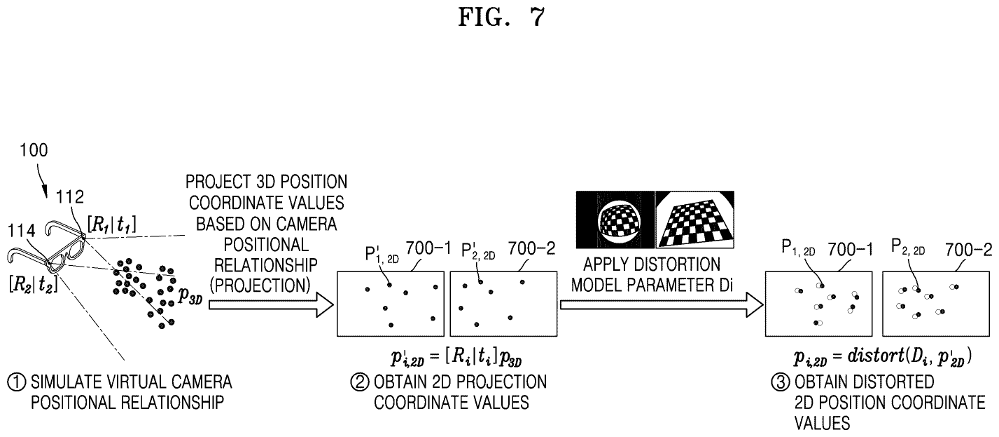

As used in the present disclosure, ‘corresponding’ may mean that 2D position coordinate values P_{L_i} and P_{R_i} for the first camera and the second camera are obtained by simulating 3D position coordinate values p_{3D_i} by reflecting camera positional relationship parameters [R_{L}|t_{L}] and [R_{R}|t_{R}] and distortion model parameters D_{L} and D_{R}. In an embodiment of the present disclosure, the 2D position coordinate values P_{L_i} and P_{R_i} may be obtained by obtaining 2D projection coordinate values by projecting the arbitrarily generated 3D position coordinate values p_{3D_i} according to camera positional relationship parameters [R_{L_i}|t_{L_i}] and [R_{R_i}|t_{R_i}] and by performing a simulation that reflects distortion of the lenses by applying distortion model parameters D_{L_i} and D_{R_i} to the obtained 2D projection coordinate values. An embodiment in which 3D position coordinate values p_{3D_i} included in the LUT 200 are arbitrarily generated and 2D position coordinate values P_{L_i} and P_{R_i} are obtained by simulating the 3D position coordinate values p_{3D_i} is described in detail with reference to FIGS. 6 and 7.

FIG. 6 is a diagram illustrating an operation in which the AR device 100 obtains 3D position coordinate values of hand joints, which are stored in a LUT, according to an embodiment of the present disclosure.

Referring to FIG. 6, the AR device 100 may obtain position information of joints included in a user's hand in a 3D spatial coordinate system. In an embodiment of the present disclosure, the AR device 100 may obtain a plurality of 3D position coordinate values p_{3D_1} to p_{3D_n} representing arbitrary 3D positions of hand joints within a range of movable angles of upper body joints according to anatomical constraints of the musculoskeletal system of the human body. The ‘range of movable angle’ refers to, for example, a range of angle values by which each of the joints included in the upper body, such as a shoulder, an arm, or an elbow, is movable by a swing motion or a spin motion about a rotation axis of each of the joints. In an embodiment of the present disclosure, the AR device 100 may obtain the plurality of 3D position coordinate values p_{3D_1} to p_{3D_n}, which are arbitrary position information of the user's hand in a 3D space, by using a standard human body model or a length of each body part of a 3D human body model. However, the present disclosure is not limited thereto, and the AR device 100 may obtain the plurality of position coordinate values p_{3D_1} to p_{3D_n} for the hand joints based on constraint information by using an inverse kinematics algorithm.

The AR device 100 may store the obtained plurality of 3D position coordinate values p_{3D_1} to p_{3D_n} in the form of the LUT (200 of FIGS. 3 and 5) in the memory (130 of FIG. 3).

In the embodiment illustrated in FIG. 6, the AR device 100 obtains the 3D position coordinate values p_{3D_1} to p_{3D_n} of the hand joints by using the constraint information according to anatomical features of the musculoskeletal system of the human body and stores them in the LUT 200, thereby preventing the generation of hand joint data representing a pose that cannot be taken due to a human body structure, and obtaining image data indicating a more natural and realistic hand pose or hand movement.

FIG. 7 is a diagram illustrating an operation in which the AR device 100 obtains 2D position coordinate values of hand joints, which are stored in a LUT, according to an embodiment of the present disclosure.

Referring to FIG. 7, the AR device 100 may simulate a virtual camera positional relationship (operation \textcircled{1}). The AR device 100 includes the first camera 112 and the second camera 114, and the first camera 112 may be simulated as being positioned at a position and in a direction according to a first positional relationship parameter [R₁|t₁] on the AR device 100, and the second camera 114 may be simulated as being positioned at a position and in a direction according to a second positional relationship parameter [R₂|t₂] on the AR device 100. A camera positional relationship parameter [R|t] is a parameter representing information about a relative position and orientation of a camera, and may include a rotation matrix R related to a rotation direction or angle, and a translation vector t related to a movement distance value.

The AR device 100 may obtain 2D projection coordinate values P′_{1, 2D} and P′_{2, 2D} by projecting 3D position coordinate values p_{3D} based on a camera positional relationship (operation \textcircled{2}). The processor (120 of FIG. 3) of the AR device 100 may calculate projection coordinate values P′_{1, 2D} and P′_{2, 2D} by projecting 3D position coordinate values p_{3D} by using positional relationship parameters [R₁|t₁] and [R₂|t₂] of the first camera 112 and the second camera 114. In an embodiment of the present disclosure, the processor 120 may obtain first camera 2D projection coordinate values P′_{1, 2D} by projecting arbitrary 3D position coordinate values (p_{3D} of FIG. 6) which are obtained by using constraint information of the musculoskeletal system of the human body, onto a first image 700-1 that is a 2D image, based on the first positional relationship parameter [R₁|t₁] of the first camera 112. Similarly, the processor 120 may obtain second camera 2D projection coordinate values P′_{2, 2D} by projecting the 3D position coordinate values p_{3D} onto a second image 700-2 based on the second positional relationship parameter [R₂|t₂] of the second camera 114.

The AR device 100 may obtain distorted 2D position coordinate values P_{1, 2D} and P_{1, 2D} by performing a simulation that applies a distortion model parameter Dᵢ to the 2D projection coordinate values P′_{1, 2D}, and P′_{2, 2D} (operation \textcircled{3}). The ‘distortion model parameter Dᵢ’ is a parameter used to simulate, through mathematical modeling, image distortion due to physical characteristics of a lens included in a camera that obtains an image. A distortion model may be defined according to the degree or type of distortion due to the physical characteristics of the lens. For example, distortion models may include a barrel distortion model, a Brown distortion model, or a pincushion distortion model, but are not limited thereto. The distorted 2D position coordinate values P_{1, 2D} and P_{1, 2D} are values calculated based on distortion that is virtually generated by assuming an ideal distortion model and applying a distortion model parameter Dᵢ of the ideal distortion model, so no error occurs.

The processor 120 of the AR device 100 may store, in the LUT (200 of FIGS. 1 and 3), the distorted 2D position coordinate values P_{1, 2D} and P_{1, 2D}, as well as the camera positional relationship parameters [R₁|t₁] and [R₂|t₂], the distortion model parameter Dᵢ, and the 3D position coordinate values p_{3D}, which are all applied during the simulation. However, the present disclosure is not limited thereto, and a simulation for obtaining the distorted 2D position coordinate values P_{1, 2D}, and P_{1, 2D} illustrated in FIG. 7 may be performed by a device other than the AR device 100 or by a server (300 of FIG. 4). In this case, the distorted 2D position coordinate values P_{1, 2D} and P_{1, 2D}, the camera positional relationship parameters [R₁|t₁] and [R₂|t₂], the distortion model parameter Dᵢ, and the 3D position coordinate values p_{3D} may be stored in the LUT 200 within another device or the server (300 of FIG. 4).

FIG. 8 is a diagram illustrating an operation in which the AR device 100 obtains 3D position information 840 of hand joints by using an AI model 800, according to an embodiment of the present disclosure.

Referring to FIG. 8, the AR device 100 may obtain a first image 831 by photographing a user's hand located in a real-world space using the first camera 112, and obtain a second image 832 by photographing the user's hand using the second camera 114. The AR device 100 may recognize feature points of hand joints from each of the first image 831 and the second image 832. A method by which the AR device 100 recognizes the feature points of the hand joints from the first image 831 and the second image 832 is the same as the method described with reference to FIG. 1, and thus, for additional implementation details, reference may be made to the descriptions of FIG. 1. The AR device 100 may obtain 2D joint coordinate values P_{1_n} and P_{2_n} of the recognized feature points of the hand joints.

The processor (120 of FIG. 3) of the AR device 100 may input, to the AI model 800, a positional relationship [R|t]810 between the first camera 112 and the second camera 114, a distortion model parameter Dᵢ 820 obtained according to physical characteristics of lenses of the first camera 112 and the second camera 114, the 2D joint coordinate values P_{1_n} obtained from the first image 831, and the 2D joint coordinate values P_{2_n} obtained from the second image 832, and obtain 3D position coordinate values through inference using the AI model 800. The processor 120 may output the 3D position coordinate values obtained from the AI model 800 as 3D position information 840 of the hand joints. In an embodiment of the present disclosure, the processor 120 may display the 3D position information 840 of the hand joints on the display (140 of FIG. 3).

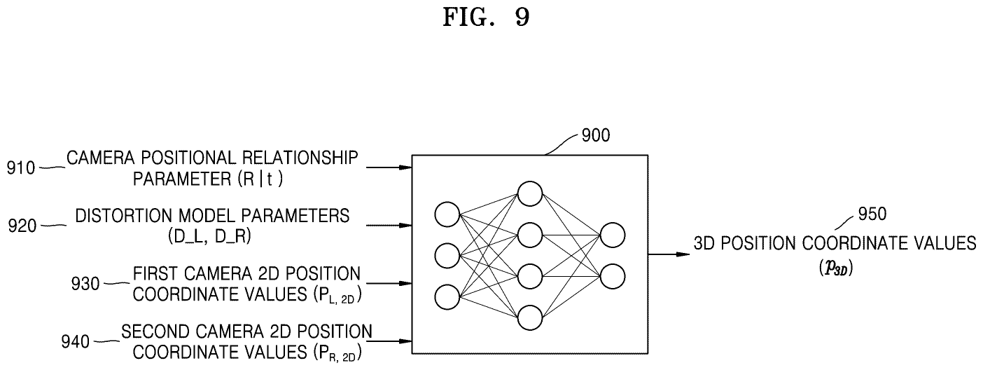

The AI model 800 may be a neural network model trained, via supervised learning, by applying, as input data, a plurality of camera positional relationship parameters, a plurality of distortion model parameters, a plurality of 2D position coordinate values for the first camera 112, and a plurality of 2D position coordinate values for the second camera 114, which are stored in the LUT (200 of FIGS. 3 and 4), and applying, as ground truth, a plurality of 3D position coordinate values respectively corresponding to the input data. A method of training the AI model 800 is described in detail with reference to FIG. 9.

FIG. 9 is a diagram illustrating a method of training an AI model 900, according to an embodiment of the present disclosure.

Referring to FIG. 9, the AI model 900 may be trained, via supervised learning, by applying, as input data, a camera positional relationship parameter [R|t]910, distortion model parameters D_{L} and D_{R} 920 of the first camera 112 and the second camera 114, 2D position coordinate values P_{L, 2D} 930 for the first camera 112, and 2D position coordinate values P_{R, 2D} 940 for the second camera 114, and applying, as ground truth, 3D position coordinate values p_{3D} 950 corresponding to the input data. In an embodiment of present disclosure, the AI model 900 may be trained by the AR device 100 and stored on-device in a storage device of the memory (130 of FIG. 3) of the AR device 100, but is not limited thereto. In an embodiment of the present disclosure, the AI model 900 may be pre-trained by the server (300 of FIG. 4). In this case, the AI model 900 may be stored in the server 300.

The AI model 900 may be implemented as a DNN model. The DNN model may include a plurality of neural network layers. Each of the plurality of neural network layers has a plurality of weight values and performs neural network computations via calculations between a result of computations in a previous layer and the plurality of weight values. A plurality of weight values assigned to each of the plurality of neural network layers may be optimized by a result of training the DNN model. For example, the plurality of weight values may be updated via backpropagation to reduce or minimize a loss or cost value obtained in the DNN model during a training process.

In an embodiment of the present disclosure, the AI model 900 may be implemented as a CNN model, but is not limited thereto. The AI model 200 may be implemented as, for example, an RNN, an RBM, a DBN, a BRDNN, a DQN, or the like.

In the embodiment illustrated in FIGS. 8 and 9, the AR device 100 obtains the 3D position information 840 of the hand joints through inference using the AI model 800 instead of using the LUT 200, thereby providing a technical effect of shortening the processing time and implementing real-time processing of hand interaction. Furthermore, according to an embodiment of the present disclosure, the AI model 900 is trained using multiple data included in the LUT 200, so that the 3D position information 840 that is robust to errors may be obtained through inference using the AI models 800 and 900. In addition, the AI model 900 is trained using data of hand joints simulated by reflecting constraints of the musculoskeletal system of the human body, thereby preventing occurrence of errors that exceed the range of movable angles of the hand joints.

FIG. 10 is a flowchart of a method, performed by the AR device 100, of determining the accuracy of 3D position information of hand joints, according to an embodiment of the present disclosure.

Operations S1010 to S1050 of FIG. 10 may be performed after operation S220 illustrated in FIG. 2 is performed.

In operation S1010, the AR device 100 corrects distortion in the 2D joint coordinate values based on distortion model parameters of lenses and a positional relationship between the plurality of cameras. In an embodiment of the present disclosure, the AR device 100 includes a left-eye camera (a first camera) and a right-eye camera (a second camera), and obtain a first image by using the left-eye camera and a second image by using the right-eye camera. The AR device 100 may obtain 2D joint coordinate values of the hand joints from the first image and the second image. The AR device 100 may correct distortion in the 2D position coordinate values of the hand joints by using positional relationship information [R|t], which indicates a relative positional relationship between the left-eye camera and the right-eye camera, and distortion model parameters that are obtained by mathematically modeling distortion models defined according to physical characteristics of the lenses included in the left-eye camera and the right-eye camera.

In operation S1020, the AR device 100 rectifies an orientation of the images based on the distortion model parameters and the positional relationship between the cameras. In an embodiment of the present disclosure, the AR device 100 may rectify the orientation of the images by aligning epipolar lines of the first image and the second image to be parallel by using the relative positional relationship information [R|t] between the left-eye camera and the right-eye camera and the distortion model parameters of the left-eye camera and the right-eye camera.

In operation S1030, the AR device 100 calculates first 3D position coordinate values of the hand joints through triangulation using the corrected 2D joint coordinate values as a result of the distortion correction and the rectification and the positional relationship between the plurality of cameras. In an embodiment of the present disclosure, the AR device 100 may obtain a 3D image by using the relative positional relationship information [R|t] between the left-eye camera and the right-eye camera and the 2D joint coordinate values obtained via operations S1010 and S1020, and calculate first 3D position coordinate values of the hand joints on the 3D image.

In operation S230, the AR device 100 obtains, from the LUT (200 of FIGS. 3 and 4), second 3D position coordinate values corresponding to distortion model parameters of lenses of the plurality of cameras, a positional relationship between the plurality of cameras, and the obtained 2D joint coordinate values. Operation S230 of FIG. 10 is the same as operation S230 illustrated in FIG. 2, and therefore, for additional implementation details, reference may be made to the descriptions of FIG. 2. In an embodiment of the present disclosure, the operation according to operation S230 may be performed concurrently with operations S1010 to S1030. Operation S230 is a separate operation from operations S1010 to S1030, and may be performed independently.

In operation S1040, the AR device 100 detects an error in the 3D position information of the hand joints by comparing the first 3D position coordinate values with the second 3D position coordinate values. In an embodiment of the present disclosure, the processor (120 of FIG. 3) of the AR device 100 may detect an error in the 3D position information of the hand joints based on at least one of a difference value between the first 3D position coordinate values and the second 3D position coordinate values, a difference value between lengths of each part of the hand respectively calculated using the first 3D position coordinate values and the second 3D position coordinate values, and an absolute value of the first 3D position coordinate values. For example, the processor 120 may calculate a difference value between the first 3D position coordinate values and the second 3D position coordinate values by using the following Equation 1.

$${\sum }_{j = 0}^{N} \vert {p}_{j}^{base} - {p}_{j}^{new} \vert \qquad [ Equation 1 ]$$

In the Equation 1 above, pⱼ^{base} may represent the first 3D position coordinate values obtained via operations S1010 to S1030, and pⱼ^{new} may represent the second 3D position coordinate values obtained via operation S230.

For example, the processor 120 may calculate a difference value between lengths of each part of the hand respectively calculated using the first 3D position coordinate values and the second 3D position coordinate values.

$${\sum }_{i = 0}^{M} \vert {l}_{i}^{base} - {l}_{i}^{new} \vert \qquad [ Equation 2 ]$$

In the Equation 2 above, lᵢ^{base} may represent a length of a part of the hand calculated based on the first 3D position coordinate values obtained in operations S1010 to S1030, and lᵢ^{new} may represent a length of the part of the hand calculated based on the second 3D position coordinate values obtained in operation S230.

For example, the processor 120 may calculate an absolute value of the first 3D position coordinate values by using the following Equation 3.

$${max}_{j} {p}_{k , j}^{base} w . r . t . k = x , y , z \qquad [ Equation 3 ]$$

In Equation 3 above, k may represent 3D coordinate x-, y-, and z-axes. In an embodiment of the present disclosure, in a case that the difference value between the first 3D position coordinate values and the second 3D position coordinate values, which is calculated by using Equation 1, or the difference value between the lengths of each part of the hand, which is calculated by using Equation 2, exceeds a preset threshold, the processor 120 may detect that an error has occurred in the 3D position information of the hand joints. In an embodiment of the present disclosure, the processor 120 may detect that an error has occurred in the 3D position information of the hand joint in a case that the absolute value of the first 3D position coordinate values calculated by using Equation 3 are 3D position coordinate values that exceed a range of movable angles of upper body joints according to anatomical constraints of the musculoskeletal system of the human body.

In a case that the error is detected in the 3D position information of the hand joints in operation S1050 (operation S1060), the AR device 100 outputs a notification message regarding a change in a method of obtaining the 3D position information of the hand joints. FIG. 11 is a diagram illustrating a UI output by the AR device 100 to notify whether a hand joint recognition method needs to be changed, according to an embodiment of the present disclosure.

Referring to operation S1060 of FIG. 10 in conjunction with FIG. 11, in a case that the error is detected in the 3D position information of the hand joints, the processor 120 of the AR device 100 may control the display (140 of FIG. 3) to output on a stereo image 1100 a notification message 1110 notifying whether a change in a hand joint recognition method is required. The notification message 1110 may be a message composed of text such as, for example, “A change in a hand recognition method is required. Do you want to change the recognition method?”. However, the present disclosure is not limited thereto, and the AR device 100 may also output a notification message regarding a change in the hand joint recognition method via voice or sound. In this case, the AR device 100 may further include an audio output device such as a speaker.

In the embodiment illustrated in FIG. 11, the notification message 1110 may include a GUI for performing an operation of changing the hand joint recognition method, such as ‘yes’ or ‘no’.

Referring back to FIG. 10, the AR device 100 performs the operation according to operation S220 again after outputting the notification message. In an embodiment of the present disclosure, the AR device 100 may obtain 2D joint coordinate values for feature points of hand joints via a changed hand joint recognition method.

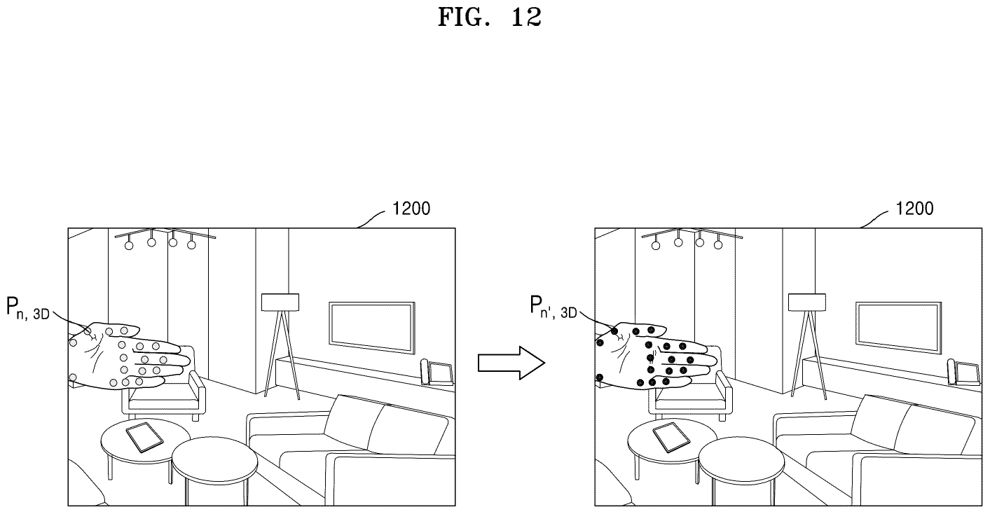

In an embodiment of the present disclosure, in a case that an error is detected in the 3D position information of the hand joints, the AR device 100 may display a position of the hand joints where the error is detected, in a color that is distinct from that for a position where the error is not detected. FIG. 12 is a diagram illustrating a UI output by an AR device to represent a recognition error of 3D position information of hand joints, according to an embodiment of the present disclosure.

Referring to FIG. 12, the AR device 100 may display 3D position information P_{n, 3D} of hand joints in a stereo image 1200 in a first color (e.g., green). In a case that an error is detected in the 3D position information P_{n, 3D} of the hand joints, the AR device 100 may display 3D position information P′_{n, 3D} of the hand joints in which the error is detected in the stereo image 1200, in a second color (e.g., red) that is distinct from the first color.

Referring back to FIG. 10, in a case that no error is detected in the 3D position information of the hand joints in operation S1050, the AR device 100 performs the operation according to operation S240.

In the embodiment illustrated in FIGS. 10 to 12, the AR device 100 obtains the first 3D position information of the hand joints by using a conventional method, i.e., distortion correction and rectification of 2D joint coordinate values and triangulation using a positional relationship between the cameras, and detects an error in the 3D position information by comparing the obtained first 3D position information with the second 3D position information obtained through the LUT 200, thereby increasing the accuracy of the 3D position information of the hand joints and thus improving the stability of hand interaction.

FIG. 13 is a flowchart of a method, performed by the AR device 100, of determining a size of a region where 3D position information of hand joints is obtained via triangulation in an entire region of an image, according to an embodiment of the present disclosure.

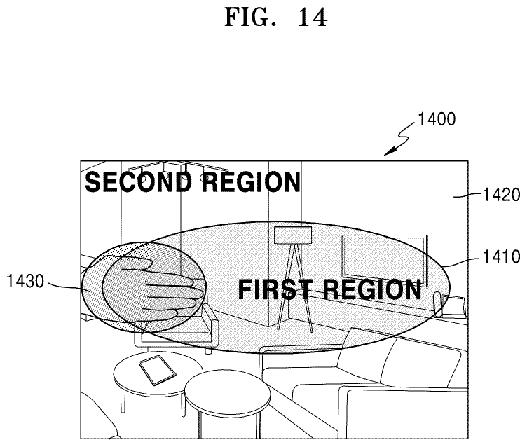

FIG. 14 is a diagram illustrating a UI output by the AR device 100 to display a region 1430 where an error occurs in 3D position information of hand joints in an entire region of a stereo image 1400, according to an embodiment of the present disclosure.

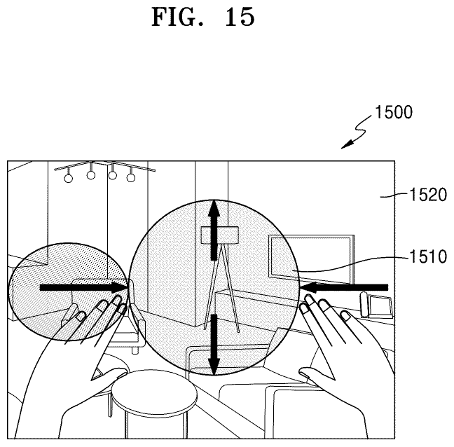

FIG. 15 is a diagram illustrating an operation in which the AR device 100 determines a size of a first region 1510 where 3D position information of hand joints is obtained via triangulation in an entire region of a stereo image 1500, according to an embodiment of the present disclosure.

Hereinafter, an operation method of the AR device 100 illustrated in FIG. 13 is described with reference to FIG. 13 in conjunction with FIGS. 14 and 15.

In operation S1310, the AR device 100 outputs a notification message regarding a change in a method for obtaining 3D position information of hand joints. Because operation S1310 is the same as operation S1060 illustrated in FIG. 10, for additional implementation details, reference may be made to the descriptions of FIG. 10.

In operation S1320, the AR device 100 displays, in distinct colors, a first region in which first 3D position coordinate values are obtained via triangulation in an entire region of an image and a second region in which second 3D position coordinate values are obtained from a LUT. Because the degree of distortion is generally large at edges of the image, the AR device 100 may obtain the second 3D position coordinate values from the LUT (200 of FIGS. 1, 3, and 4) for the second region that is an edge portion of the image, and obtain the first 3D position coordinate values through triangulation for the first region that includes a center portion of the image. Referring to FIG. 14 together, the AR device 100 may display, in different colors, a first region 1410 including a center portion in an entire region of the stereo image 1400 and a second region 1420 that is the remaining portion of the entire region excluding the first region 1410. For example, the AR device 100 may display the first region 1410 in green and the second region 1420 in blue. However, the present disclosure is not limited thereto.

In an embodiment of the present disclosure, when a user input for selecting a change in a hand joint recognition method in the notification message (1110 of FIG. 11) is received (e.g., when “Yes” is selected in the notification message 1110 illustrated in FIG. 11), the AR device 100 may display the first region 1410 and the second region 1420 of the entire region of the stereo image 1400 in distinct colors. However, the present disclosure is not limited thereto, and in an embodiment of the present disclosure, the AR device 100 may display a UI for changing a hand joint recognition method, and when a user input is received via the UI, display the first region 1410 and the second region 1420 of the entire region of the stereo image 1400 in distinct colors.

Referring back to FIG. 13, in operation S1330, the AR device 100 displays a region in the image where an error in the 3D position information of the hand joints has been detected. Referring to FIG. 14 together, the AR device 100 may display a third region 1430 in which an error has occurred in the 3D position information of the hand joints in the entire region of the stereo image 1400. In an embodiment of the present disclosure, the AR device 100 may display the third region 1430 in which the error has been detected, in a color that is distinct from those for the first region 1410 and the second region 1420. For example, the AR device 100 may display the third region 1430 in red, but is not limited thereto.

Referring back to FIG. 13, in operation S1340, the AR device 100 recognizes 2D joint coordinate values of a hand in the image. In an embodiment of the present disclosure, the AR device 100 may recognize feature points of hand joints from the image, and obtain 2D joint coordinate values of the recognized feature points of the hand joints. A method by which the AR device 100 obtains the 2D joint coordinate values is the same as the method described with reference to operations S210 and S220 illustrated in FIG. 2, and therefore, for additional implementation details, reference may be made to the descriptions of FIG. 2.

In operation S1350, the AR device 100 detects whether there is a movement of the hand based on 2D joint coordinate values recognized for a preset time period. In an embodiment of the present disclosure, the AR device 100 may recognize a plurality of 2D joint coordinate values from a plurality of image frames obtained for the preset time period, and detect a movement of the hand based on the recognized plurality of 2D joint coordinate values.

In a case that the movement of the hand is detected (S1360), the AR device 100 adjusts sizes of a horizontal axis and a vertical axis of the first region 1510 based on the movement of the hand. Referring to FIG. 15 together, the AR device 100 may change a size and a shape of the first region 1510 in the entire region of the stereo image 1500 based on a recognized movement of the hand. The AR device 100 may change the size and shape of the first region 1510 by adjusting the sizes of the horizontal axis and the vertical axis of the first region 1510 based on the movement of the hand. As the size and shape of the first region 1510 changes, a size and a shape of the second region 1520 may also change.

Referring back to FIG. 13, after adjusting the sizes of the horizontal axis and the vertical axis of the first region 1510, the AR device 100 may return to operation S1340 and recognize 2D joint coordinate values of the hand.

In a case that the movement of the hand is not detected in operation S1350, the AR device 100 may end the process after storing the first region and the second region.

The present disclosure provides an AR device 100 for obtaining 3D position information of hand joints. According to an embodiment of the present disclosure, the AR device 100 may include a plurality of cameras 112 and 114 configured to obtain a plurality of images by photographing a user's hand, a memory 130 storing a LUT 200, and at least one processor 120. The at least one processor 120 may be configured to recognize hand joints from the plurality of images obtained through the plurality of cameras 112 and 114. The at least one processor 120 may be configured to obtain 2D joint coordinate values for feature points of the recognized hand joints. The at least one processor 120 may be configured to obtain, from the LUT 200, 3D position coordinate values corresponding to distortion model parameters of the plurality of cameras 112 and 114, a positional relationship between the plurality of cameras 112 and 114, and the obtained 2D joint coordinate values. The at least one processor 120 may be configured to output 3D position information of the hand joints based on the obtained 3D position coordinate values.

In an embodiment of the present disclosure, the LUT 200 may include a plurality of 2D position coordinate values, a plurality of distortion model parameters, a plurality of camera positional relationship parameters, and a plurality of 3D position coordinate values, which are all pre-obtained. The plurality of 2D position coordinate values may be obtained through a simulation that applies the plurality of distortion model parameters and the plurality of camera positional relationship parameters to the plurality of 3D position coordinate values.

In an embodiment of the present disclosure, the plurality of 3D position coordinate values included in the LUT 200 may be coordinate values representing arbitrary 3D positions of the hand joints within a range of movable angles of upper body joints according to anatomical constraints of a musculoskeletal system of a human body.

In an embodiment of the present disclosure, the plurality of 2D position coordinate values included in the LUT 200 may be obtained through a simulation of obtaining 2D projection coordinate values by projecting the plurality of 3D position coordinate values based on the plurality of camera positional relationship parameters and reflecting distortion of lenses by applying the plurality of distortion model parameters to the obtained 2D projection coordinate values.

In an embodiment of the present disclosure, the at least one processor 120 may be configured to access the LUT 200 and search the LUT 200 for a distortion model parameter, a camera positional relationship parameter, and 2D position coordinate values that are respectively identical or similar to the distortion model parameters of the lenses, the positional relationship between the plurality of cameras, and the obtained 2D joint coordinate values. The at least one processor 120 may be configured to obtain, from the LUT 200, the 3D position coordinate values corresponding to found distortion model parameter, found camera positional relationship parameter, and found 2D position coordinate values.

In an embodiment of the present disclosure, the at least one processor 120 may be configured to input the distortion model parameters of the lenses, the positional relationship between the plurality of cameras, and the obtained 2D joint coordinate values to an AI model trained using the LUT 200, and obtain the 3D position coordinate values through inference using the AI model.

In an embodiment of the present disclosure, the AI model may be a DNN model trained, via supervised learning, by applying the plurality of distortion model parameters, the plurality of camera positional relationship parameters, and the plurality of 2D position coordinate values as input data, and applying the plurality of 3D position coordinate values as ground truth.

In an embodiment of the present disclosure, the at least one processor 120 may be configured to correct distortion in the 2D joint coordinate values based on the distortion model parameters of the lenses and the positional relationship between the plurality of cameras, and perform rectification on orientations of the plurality of images. The at least one processor 120 may be configured to calculate first 3D position coordinate values of the hand joints through triangulation by using corrected 2D joint coordinate values resulting from the distortion correction and the rectification and the positional relationship between the plurality of cameras. The at least one processor 120 may be configured to detect an error in the 3D position information of the hand joints by comparing the calculated first 3D position coordinate values with second 3D position coordinate values obtained from the LUT 200.

In an embodiment of the present disclosure, the at least one processor 120 may be configured to detect whether there is an error in recognition the 3D position information of the hand joints based on at least one of a difference value between the first 3D position coordinate values and the second 3D position coordinate values, a difference value between a first length of the hand joints calculated using the first 3D position coordinate values and a second length of the hand joints calculated using the second 3D position coordinate values, and an absolute value of the first 3D position coordinate values.

In an embodiment of the present disclosure, the AR device 100 may further include a display 140. The at least one processor 120 may control the display 140 to display a position of hand joints in which the error is detected, in a color that is distinct from a color for a position in which the error is not detected.

In an embodiment of the present disclosure, the at least one processor 120 may control the display 140 to display, in distinct colors, a first region in which the first 3D position coordinate values are obtained through triangulation in an entire region of the plurality of images, and a second region in which the second 3D position coordinate values are obtained from the LUT 200. In an embodiment of the present disclosure, the at least one processor 120 may detect a movement of the user's hand for adjusting a size of the first region, and change sizes of horizontal and vertical axes of the first region based on the detected movement of the user's hand.

The present disclosure provides a method, performed by an AR device 100, of obtaining 3D position information of hand joints. The method may include recognizing the hand joints from a plurality of images obtained by photographing a user's hand using a plurality of cameras 112 and 114 (S210). The method may include obtaining 2D joint coordinate values for feature points of the recognized hand joints (S220). The method may include obtaining, from a LUT 200 prestored in a memory 130, 3D position coordinate values corresponding to distortion model parameters of the plurality of cameras, a positional relationship between the plurality of cameras, and the obtained 2D joint coordinate values (S230). The method may include outputting the 3D position information of the hand joints based on the obtained 3D position coordinate values (S240).

In an embodiment of the present disclosure, the LUT 200 may include a plurality of 2D position coordinate values, a plurality of distortion model parameters, a plurality of camera positional relationship parameters, and a plurality of 3D position coordinate values, which are all pre-obtained. The plurality of 2D position coordinate values may be obtained through a simulation that applies the plurality of distortion model parameters and the plurality of camera positional relationship parameters to the plurality of 3D position coordinate values.

In an embodiment of the present disclosure, the plurality of 3D position coordinate values included in the LUT 200 may be coordinate values representing arbitrary 3D positions of the hand joints within a range of movable angles of upper body joints according to anatomical constraints of a musculoskeletal system of a human body.

In an embodiment of the present disclosure, the plurality of 2D position coordinate values included in the LUT 200 may be obtained through a simulation of obtaining 2D projection coordinate values by projecting the plurality of 3D position coordinate values based on the plurality of camera positional relationship parameters and reflecting distortion of lenses by applying the plurality of distortion model parameters to the obtained 2D projection coordinate values.

In an embodiment of the present disclosure, the obtaining of the 3D position coordinate values (S230) may include accessing the LUT 200 and searching the LUT 200 for a distortion model parameter, a camera positional relationship parameter, and 2D position coordinate values that are respectively identical or similar to the distortion model parameters of the lenses, the positional relationship between the plurality of cameras, and the obtained 2D joint coordinate values. The obtaining of the 3D position coordinate values (S230) may include obtaining, from the LUT 200, the 3D position coordinate values corresponding to the found distortion model parameter, found camera positional relationship parameter, and found 2D position coordinate values.

In an embodiment of the present disclosure, the obtaining of the 3D position coordinate values (S230) may include inputting the distortion model parameters of the lenses, the positional relationship between the plurality of cameras, and the obtained 2D joint coordinate values to an AI model trained using the LUT 200, and obtaining the 3D position coordinate values through inference using the AI model.

In an embodiment of the present disclosure, the AI model may be a DNN model trained, via supervised learning, by applying the plurality of distortion model parameters, the plurality of camera positional relationship parameters, and the plurality of 2D position coordinate values as input data, and applying the plurality of 3D position coordinate values as ground truth.

In an embodiment of the present disclosure, the method may include correcting distortion in the 2D joint coordinate values based on the distortion model parameters of the lenses and the positional relationship between the plurality of cameras, and performing rectification on orientations of the plurality of images (S1010) and calculating first 3D position coordinate values of the hand joints through triangulation by using 2D joint coordinate values corrected as a result of the distortion correction and the rectification and the positional relationship between the plurality of cameras (S1020). The method may include detecting an error in the 3D position information of the hand joints by comparing the calculated first 3D position coordinate values with second 3D position coordinate values obtained from the LUT 200 (S1030).

In an embodiment of the present disclosure, the method may further include displaying a position of hand joints in which the error is detected, in a color that is distinct from a color for a position in which the error is not detected.

In an embodiment of the present disclosure, the method may further include displaying, in distinct colors, a first region in which the first 3D position coordinate values are obtained through triangulation in an entire region of the plurality of images, and a second region in which the second 3D position coordinate values are obtained from the LUT 200 (S1320). The method may further include detecting a movement of the user's hand for adjusting a size of the first region (S1340), and changing sizes of a horizontal axis and a vertical axis of the first region based on the detected movement of the user's hand (S1350).

The present disclosure provides a computer program product including a computer-readable storage medium. The storage medium may include instructions that are readable by an AR device 100 to recognize hand joints from a plurality of images obtained by photographing a user's hand using a plurality of cameras 112 and 114, obtain 2D joint coordinate values for feature points of the recognized hand joints, obtain, from a LUT prestored in a memory, 3D position coordinate values corresponding to distortion model parameters of the plurality of cameras, a positional relationship between the plurality of cameras, and the obtained 2D joint coordinate values, and output 3D position information of the hand joints based on the obtained 3D position coordinate values.

A program executed by the AR device 100 described in the present disclosure may be implemented as a hardware component, a software component, and/or a combination of the hardware component and the software component. The program may be executed by any system capable of executing computer-readable instructions.

Software may include a computer program, a piece of code, an instruction, or a combination of one or more thereof, and configure a processing device to operate as desired or instruct the processing device independently or collectively.

The software may be implemented as a computer program including instructions stored in computer-readable storage media. Examples of the computer-readable recording media include magnetic storage media (e.g., ROM, RAM, floppy disks, hard disks, etc.), optical recording media (e.g., compact disc (CD)-ROM and a digital versatile disc (DVD)), etc. The computer-readable recording media may be distributed over computer systems connected through a network so that computer-readable code may be stored and executed in a distributed manner. The media may be readable by a computer, stored in a memory, and executed by a processor.

A computer-readable storage medium may be provided in the form of a non-transitory storage medium. In this regard, the term ‘non-transitory’ only means that the storage medium does not include a signal and is a tangible device, and the term does not differentiate between where data is semi-permanently stored in the storage medium and where the data is temporarily stored in the storage medium. For example, the ‘non-transitory storage medium’ may include a buffer in which data is temporarily stored.

Furthermore, programs according to embodiments disclosed in the present specification may be included in a computer program product when provided. The computer program product may be traded, as a product, between a seller and a buyer.

The computer program product may include a software program and a computer-readable storage medium having stored thereon the software program. For example, the computer program product may include a product (e.g., a downloadable application) in the form of a software program electronically distributed by a manufacturer of the AR device 100 or through an electronic market (e.g., Samsung Galaxy Store™). For such electronic distribution, at least a part of the software program may be stored in the storage medium or may be temporarily generated. In this case, the storage medium may be a storage medium of a server of a manufacturer of the AR device 100, a server of the electronic market, or a relay server for temporarily storing the software program.

In a system consisting of the AR device 100 and/or a server, the computer program product may include a storage medium of the server or a storage medium of the AR device 100. In a case where there is a third device (e.g., a mobile device) communicatively connected to the AR device 100, the computer program product may include a storage medium of the third device. The computer program product may include a software program itself that is transmitted from the AR device 100 to the third device or that is transmitted from the third device to an electronic device.

In this case, one of the AR device 100 and the third device may execute the computer program product to perform methods according to the disclosed embodiments. Att least one of the AR device 100 or the third device may execute the computer program product to perform the methods according to the disclosed embodiments in a distributed manner.

For example, the electronic device 100 may execute the computer program product stored in the memory (130 of FIG. 3) to control another electronic device communicatively connected to the AR device 100 to perform the methods according to the disclosed embodiments.

In another example, the third device may execute the computer program product to control an electronic device communicatively connected to the third device to perform the methods according to the disclosed embodiments.

In a case where the third device executes the computer program product, the third device may download the computer program product from the AR device 100 and execute the downloaded computer program product. The third device may execute the computer program product that is pre-loaded therein to perform the methods according to the disclosed embodiments.

While the embodiments have been described above with reference to limited examples and figures, it will be understood by those of ordinary skill in the art that various modifications and changes in form and details may be made from the above descriptions. For example, adequate effects may be achieved even when the above-described techniques are performed in a different order than that described above, and/or the aforementioned components such as computer systems or modules are coupled or combined in different forms and modes than those described above or are replaced or supplemented by other components or their equivalents.

What is claimed is:

1. An augmented reality device for obtaining three-dimensional (3D) position information of a plurality of hand joints of a user, the augmented reality device comprising:
a plurality of cameras configured to obtain a plurality of images by photographing a hand of the user;
memory storing instructions; and
at least one processor,
wherein the instructions, when executed by the at least one processor, individually or collectively, cause the augmented reality device to:
recognize the plurality of hand joints from the plurality of images obtained through the plurality of cameras,
obtain a plurality of two-dimensional (2D) joint coordinate values for a plurality of feature points corresponding to the plurality of hand joints,
obtain, from a look up table (LUT), a plurality of 3D position coordinate values corresponding to a plurality of distortion model parameters of the plurality of cameras, a positional relationship between the plurality of cameras, and the plurality of 2D joint coordinate values, and
output the 3D position information of the plurality of hand joints based on the plurality of 3D position coordinate values.

2. The augmented reality device of claim 1, wherein the LUT comprises:
the plurality of 2D position coordinate values, the plurality of distortion model parameters, a plurality of camera positional relationship parameters, and the plurality of 3D position coordinate values, each of which are pre-obtained, and
wherein the plurality of 2D position coordinate values are obtained through a simulation that applies the plurality of distortion model parameters and the plurality of camera positional relationship parameters to the plurality of 3D position coordinate values.

3. The augmented reality device of claim 2, wherein the plurality of 3D position coordinate values included in the LUT are coordinate values representing arbitrary 3D positions of the plurality of hand joints within a range of movable angles of upper body joints according to anatomical constraints of a musculoskeletal system of a human body.

4. The augmented reality device of claim 2, wherein the plurality of 3D position coordinate values included in the LUT are obtained through a simulation of obtaining 2D projection coordinate values by projecting the plurality of 3D position coordinate values based on a plurality of camera positional relationship parameters and reflecting distortion of a plurality of lenses by applying the plurality of distortion model parameters to the obtained 2D projection coordinate values.

5. The augmented reality device of claim 4, wherein the instructions, when executed by the at least one processor, individually or collectively, cause the augmented reality device to:
access the LUT and search the LUT to identify a distortion model parameter, a camera positional relationship parameter, and the plurality of 2D position coordinate values based on correspondences with the plurality of distortion model parameters of the plurality of lenses, the positional relationship between the plurality of cameras, and the plurality of 2D joint coordinate values; and
obtain, from the LUT, the plurality of 3D position coordinate values corresponding to the distortion model parameter, the camera positional relationship parameter, and the plurality of 2D position coordinate values.

6. The augmented reality device of claim 4, wherein the instructions, when executed by the at least one processor, individually or collectively, cause the augmented reality device to:
input into an artificial intelligence (AI) model, the plurality of distortion model parameters of the plurality of lenses, the positional relationship between the plurality of cameras, and the plurality of 2D joint coordinate values, wherein the AI model is trained using the LUT; and
obtain the plurality of 3D position coordinate values through inference of the AI model.

7. The augmented reality device of claim 4, wherein the instructions, when executed by the at least one processor, individually or collectively, cause the augmented reality device to:
correct distortion in the plurality of 2D joint coordinate values based on the plurality of distortion model parameters of the plurality of lenses and the positional relationship between the plurality of cameras, and rectify a plurality of orientations of the plurality of images;
calculate a first plurality of 3D position coordinate values of the plurality of hand joints through triangulation based on the plurality of corrected 2D joint coordinate values, the rectified plurality of orientations, and the positional relationship between the plurality of cameras; and
detect an error in the 3D position information of the plurality of hand joints by comparing the calculated first plurality of 3D position coordinate values with a second plurality of 3D position coordinate values obtained from the LUT.

8. A method, performed by an augmented reality device, for obtaining three-dimensional (3D) position information of plurality of hand joints of a user, the method comprising:
recognizing the plurality of hand joints from a plurality of images obtained by photographing a hand of the user using a plurality of cameras;
obtaining a plurality of two-dimensional (2D) joint coordinate values for a plurality of feature points corresponding to the recognized plurality of hand joints;
obtaining, from a look-up table (LUT) prestored in memory, 3D position coordinate values corresponding to distortion model parameters of the plurality of cameras, a positional relationship between the plurality of cameras, and the plurality of 2D joint coordinate values; and
outputting the 3D position information of the plurality of hand joints based on the plurality of 3D position coordinate values.

9. The method of claim 8, wherein the LUT comprises:
the plurality of 2D position coordinate values, the plurality of distortion model parameters, a plurality of camera positional relationship parameters, and a the plurality of 3D position coordinate values, each of which are pre-obtained, and
wherein the plurality of 2D position coordinate values are obtained through a simulation that applies the plurality of distortion model parameters and the plurality of camera positional relationship parameters to the plurality of 3D position coordinate values.

10. The method of claim 9, wherein the plurality of 3D position coordinate values included in the LUT are coordinate values representing arbitrary 3D positions of the plurality of hand joints within a range of movable angles of upper body joints according to anatomical constraints of a musculoskeletal system of a human body.

11. The method of claim 9, wherein the plurality of 3D position coordinate values included in the LUT are obtained through a simulation of obtaining 2D projection coordinate values by projecting the plurality of 3D position coordinate values based on the plurality of camera positional relationship parameters and reflecting distortion of a plurality of lenses by applying the plurality of distortion model parameters to the obtained 2D projection coordinate values.

12. The method of claim 11, wherein
the obtaining of the 3D position coordinate values comprises:
accessing the LUT and searching the LUT to identify a distortion model parameter, a camera positional relationship parameter, and the plurality of 2D position coordinate values based on correspondences with the plurality of distortion model parameters of the plurality of lenses, the positional relationship between the plurality of cameras, and the plurality of 2D joint coordinate values; and
obtaining, from the LUT, the plurality of 3D position coordinate values corresponding to the distortion model parameter, the camera positional relationship parameter, and the plurality of 2D position coordinate values.

13. The method of claim 11, wherein the obtaining of the 3D position coordinate values comprises:
inputting into an artificial intelligence model (AI), the plurality of distortion model parameters of the plurality of lenses, the positional relationship between the plurality of cameras, and the plurality of 2D joint coordinate values; and
obtaining the plurality of 3D position coordinate values through inference of the AI model.

14. The method of claim 11, further comprising:
correcting distortion in the plurality of 2D joint coordinate values based on the plurality of distortion model parameters of the plurality of lenses and the positional relationship between the plurality of cameras, and rectifying a plurality of orientations of the plurality of images;
calculating a first plurality of 3D position coordinate values of the plurality of hand joints through triangulation based on the plurality of corrected 2D joint coordinate values, the rectified plurality of orientations, and the positional relationship between the plurality of cameras; and
detecting an error in the 3D position information of the plurality of hand joints by comparing the calculated first 3D position coordinate values with a second plurality of 3D position coordinate values obtained from the LUT.

15. A non-transitory computer-readable storage medium having at least one instruction recorded thereon, that, when executed by at least one processor of an augmented reality device, for obtaining three-dimensional (3D) position information of plurality of hand joints of a user, individually or collectively, cause the augmented reality device to:
recognize the plurality of hand joints from a plurality of images obtained by photographing a hand of the user using a plurality of cameras;
obtain a plurality of two-dimensional (2D) joint coordinate values for a plurality of feature points of the recognized plurality of hand joints;
obtain, from a prestored look-up table (LUT), 3D position coordinate values corresponding to distortion model parameters of the plurality of cameras, a positional relationship between the plurality of cameras, and the plurality of 2D joint coordinate values; and
output the 3D position information of the plurality of hand joints based on the plurality of 3D position coordinate values.
